(19) United States
(12) Patent Application Publication
(10) Pub. No.: US 2022/0377714 A1
(43) Pub. Date: Nov. 24, 2022

(54) PHYSICAL RESOURCE BLOCK (PRB) SET AVAILABILITY INDICATION

(71) Applicant: Telefonaktiebolaget LM Ericsson (publ), Stockholm (SE)

(72) Inventors: Yuhang LIU, LUND (SE); Jung-Fu CHENG, FREMONT, CA (US); Hazhir SHOKRI RAZAGHI, SOLNA (SE); Stephen GRANT, PLEASANTON, CA (US); Reem KARAKI, AACHEN (DE)

(21) Appl. No.: 17/764,214

(22) PCT Filed: Sep. 25, 2020
(86) PCT No.: PCT/EP2020/076957

§ 371 Date: Mar. 28, 2022

Related U.S. Application Data
(60) Provisional application No. 62/907,110, filed on Sep. 27, 2019.

(51) Int. Cl. H04W 72/04; H04W 74/08

(52) U.S. Cl. CPC H04W 72/042; H04W 74/0808; H04W 72/0446

(57) ABSTRACT

Embodiments of a method performed by a wireless communication device for a cellular communications system are disclosed. In one embodiment, the method includes receiving serving cell configurations for a configured serving cell(s) of the wireless communication device and receiving a Downlink Control Information (DCI) from a network node. The DCI includes a slot format combination indication(s) for a configured serving cell(s) of the wireless communication device, wherein each slot format combination indication is an indication of a slot format(s) for a slot(s) on at least one respective configured serving cell of the wireless communication device. The DCI further includes a Resource Block (RB) set indication(s) each including a bit(s) that indicate availability of a RB set(s) for at least one respective configured serving cell of the wireless communication device. The method further includes decoding the DCI based on the serving cell configurations.

### RELATED APPLICATIONS

This application claims the benefit of provisional patent application Ser. No. 62/907,110, filed Sep. 27, 2019, the disclosure of which is hereby incorporated herein by reference in its entirety.

### TECHNICAL FIELD

The present disclosure relates to a cellular communications system and, in particular, to operation of a cellular communications system in accordance with a Time Division Duplexing (TDD) scheme in unlicensed spectrum.

### BACKGROUND

The Next Generation (NG) mobile wireless communication system, which is referred to as Fifth Generation (5G) or New Radio (NR), supports a diverse set of use cases and a diverse set of deployment scenarios. The later includes deployment at both low frequencies (100s of Megahertz (MHz)), similar to Long Term Evolution (LTE) today, and very high frequencies (millimeter (mm) waves in the tens of Gigahertz (GHz)).

Similar to LTE, NR uses Orthogonal Frequency Division Multiplexing (OFDM) in the downlink from a network node (e.g., base station, e.g., next generation Node B (gNB) or enhanced or evolved Node B (eNB)) to a User Equipment (UE). The basic NR physical resource over an antenna port can thus be seen as a time-frequency grid as illustrated in FIG. 1, where a Resource Block (RB) in a 14-symbol slot is shown. A RB corresponds to 12 contiguous subcarriers in the frequency domain. RBs are numbered in the frequency domain, starting with 0 from one end of the system bandwidth. Each Resource Element (RE) corresponds to one OFDM subcarrier during one OFDM symbol interval.

Different subcarrier spacing values are supported in NR. The supported subcarrier spacing values (also referred to as different numerologies) are given by Δf=(15×2\hat{ }α) kilohertz (kHz) where α∈(0,1,2,3,4). Δf=15 kHz is the basic (or reference) subcarrier spacing that is also used in LTE.

In the time domain, downlink and uplink transmissions in NR will be organized into equally-sized subframes of 1 millisecond (ms) each, similar to LTE. A subframe is further divided into multiple slots of equal duration. The slot length for subcarrier spacing Δf=(15×2\hat{ }α) kHz is ½\hat{ }α ms. There is only one slot per subframe for Δf=15 kHz and a slot consists of 14 OFDM symbols.

Downlink transmissions are dynamically scheduled, i.e., in each slot the gNB transmits Downlink Control Information (DCI) about which UE data is to be transmitted to and which RBs in the current downlink slot the data is transmitted on. This control information is typically transmitted in the first one or two OFDM symbols in each slot in NR. The DCI is carried on the Physical Control Channel (PDCCH) and data is carried on the Physical Downlink Shared Channel (PDSCH). A UE first detects and decodes PDCCH and if a PDCCH is decoded successfully, it then decodes the corresponding PDSCH based on the downlink assignment provided by decoded DCI in the PDCCH.

In addition to PDCCH and PDSCH, there are also other channels and reference signals transmitted in the downlink, including Synchronization Signal Block (SSB), Channel State Information Reference Signal (CSI-RS), etc.

Uplink data transmissions, carried on Physical Uplink Shared Channel (PUSCH), are also dynamically scheduled by the gNB by transmitting a DCI. The DCI (which is transmitted in the downlink region) always indicates a scheduling offset so that the PUSCH is transmitted in a slot in the uplink region.

In NR, both semi-statically configured Time Division Duplexing (TDD) and dynamic TDD are supported. For the latter, the scheduling DCI (downlink assignment/ uplink grant) indicates which symbols within a slot are to be used for downlink reception and uplink transmission by the UE.

For semi-static TDD, the configuration of uplink-downlink patterns is very flexible. For a particular slot within the TDD pattern, symbols may be configured as either downlink (denoted ‘D’), uplink (denoted ‘U’), or flexible (denoted ‘F’). One use of symbols classified as ‘F’ is to create a guard period for DL-to-UL or UL-to-DL transitions for half-duplex devices (half-duplex Frequency Division Duplexing (FDD) or TDD). A cell-specific TDD pattern is either provided by a System Information Block (SIB) (standalone operation) or by Radio Resource Control (RRC) (non-standalone operation). Additionally, a UE-specific TDD pattern can be configured to override symbols of the cell-specific configuration which are classified as flexible (‘F’).

For dynamic TDD where the UL/DL allocation may vary depending on the scheduling DCI, it can be useful to indicate to a group of UEs what the instantaneous TDD pattern looks like for the current and potentially future slots. This is achieved through Group Common (GC) signaling on GC-PDCCH carrying a DCI message with Format 2_0. DCI Format 2_0 contains one or more Slot Format Indicators (SFIs) indicating which symbols are classified as ‘D’, ‘U’, or ‘F’ within each of the indicated slots.

In regard to semi-static UL-DL configuration, cell-specific semi-static configuration of the TDD pattern(s) is provided from the network to the UE by the information element (IE) TDD-UL-DL-ConfigCommon, which is defined in 3GPP Technical Specification 38.331 V15.6.0 as follows:

| | |
|---|---|
| TDD-UL-DL-ConfigCommon ::= | SEQUENCE { |
| referenceSubcarrierSpacing | SubcarrierSpacing, |
| pattern1 | TDD-UL-DL-Pattern, |
| pattern2 | TDD-UL-DL-Pattern |

OPTIONAL, -- Need R
...
}

| | |
|---|---|
| TDD-UL-DL-Pattern ::= | SEQUENCE { |
| dl-UL-TransmissionPeriodicity | ENUMERATED {ms0p5, |

ms0p625, ms1, ms1p25, ms2, ms2p5, ms5, ms10},

| | |
|---|---|
| nrofDownlinkSlots | INTEGER |

(0..maxNrofSlots) ,

| | |
|---|---|
| nrofDownlinkSymbols | INTEGER |

(0..maxNrofSymbols-1) ,

| | |
|---|---|
| nrofUplinkSlots | INTEGER |

(0..maxNrofSlots) ,

| | |
|---|---|
| nrofUplinkSymbols | INTEGER |

```
(0..maxNrofSymbols-1) ,
  ...,
  [[
```

| | |
|---|---|
| dl-UL-TransmissionPeriodicity-v1530 | ENUMERATED {ms3, |
| | ms4} |

OPTIONAL -- Need R
]]
}

This IE provides the option to provide up to two concatenated TDD patterns (pattern1, pattern2), each with its own periodicity. There is a constraint that the concatenated pattern must have a total periodicity that divides 20 ms evenly in order to align with the default Synchronization Signal (SS)/Physical Broadcast Channel (PBCH) block (SSB) periodicity of 20 ms assumed by the UE upon accessing a cell i.e. devices that are doing initial cell search or devices in inactive/idle state doing cell search for mobility.

For each of the one or two concatenated patterns, the above IE defines the TDD pattern as follows:
Number of full downlink slots, where all symbols of these slots are classified as ‘D’, by nrofDownfinkSlots.
Number of symbols classified as ‘D’ in a partial downlink slot following the last full downlink slot by nrofDownlinkSymbols.
Number of symbols classified as ‘U’ in a partial uplink slot preceding the first full uplink by nrofUplinkSymbols.
Number of full uplink slots, where all symbols of these slots are classified as ‘U’, by nrofUplinkSlots.

Periodicity, in ms, after which the pattern repeats by dl-UL-TransmissionPeriodicity.

All symbols not classified as either ‘D’ or ‘U’ are assumed to be classified as ‘F’.

FIG. 2 shows a few exemplary cell-specific TDD patterns that can be configured semi-statically by TDD-UL-DL-ConfigCommon.

As mentioned above, an individual UE can be semi-statically configured with a UE-specific TDD pattern that overrides parts of the cell-specifically configured pattern. UE-specific semi-static configuration of a TDD pattern is provided from the network to the UE by the information element TDD-UL-DL-ConfigDedicated, which is defined in 3GPP TS 38.331 as follows:

| | |
|---|---|
| TDD-UL-DL-ConfigDedicated ::= | SEQUENCE { |
| slotSpecificConfigurationsToAddModList | SEQUENCE (SIZE |
| (1..maxNrofSlots)) OF TDD-UL-DL-SlotConfig | OPTIONAL, -- |

Need N

| | |
|---|---|
| slotSpecificConfigurationsToreleaseList | SEQUENCE (SIZE |
| (1..maxNrofSlots)) OF TDD-UL-DL-SlotIndex | OPTIONAL, -- |

Need N
...
}

| | |
|---|---|
| TDD-UL-DL-SlotConfig ::= | SEQUENCE { |
| slotIndex | TDD-UL-DL-SlotIndex, |
| symbols | CHOICE { |
| allDownlink | NULL, |
| allUplink | NULL, |
| explicit | SEQUENCE { |
| nrofDownlinkSymbols | INTEGER |
| (1..maxNrofSymbols-1) | OPTIONAL, |

-- Need S

| | |
|---|---|
| nrofUplinkSymbols | INTEGER |
| (1..maxNrofSymbols-1) | OPTIONAL |

```
-- Need S
    }
  }
}
```

| | |
|---|---|
| TDD-UL-DL-SlotIndex ::= | INTEGER (0..maxNrofSlots-1) |

This IE contains a list of slots within the cell-specific TDD pattern for which the symbol classification should be overridden; however, this override can only be applied to symbols classified as flexible (‘F’). For each indicated slot, the flexible symbols can be re-classified as ‘allDownlink’, ‘allUplink’, or ‘explicit’. For ‘explicit’, the number of symbols at the beginning of the slot classified as ‘D’ is configured, and the number of symbols at the end of the slot classified as ‘U’ is configured.

As mentioned above, in the case of dynamic TDD where the UL/DL allocation may vary depending on the scheduling DCI, it can be useful to indicate to a group of UEs what the instantaneous TDD pattern looks like for the current and potentially future slots. This is achieved by signaling of one or more SFIs in DCI Format 2_0 carried by the so-called GC-PDCCH. Each SFI indicates which symbols in a slot are classified as ‘D’, ‘U’, or ‘F’. The indicated SFI(s) cannot override symbols that are already semi-statically configured as ‘D’ or ‘U’; however, an SFI can indicate the direction (‘D’ or ‘U’) for symbols classified as flexible (‘F’). If the SFI indicates ‘F’ for symbols already classified as ‘F’, and PDCCH does not schedule any data or trigger reference signals in those symbols, then the UE shall neither transmit nor receive on those symbols. This can be useful to cancel an instance of a periodically transmitted/received reference signals (e.g., SRS, CSI-RS) to create ‘reserved resources’ for use by another technology, e.g., LTE. It can also be useful to create reserved resources (no transmission or reception by any UE) in the case that the SFI indicates ‘F’ for a symbol that is already semi-statically configured as ‘X.’

In NR-U, it is highly likely that there is no semi-static/static indication of direction of transmission since the transmission from gNB falls into a specific interval (Transmit Opportunity (TXOP) or Channel Occupancy Time (COT)) which depends on the LBT outcome so gNB does not know when it can acquire the channel. Therefore, the transmission direction would be decided on the spot and according to LBT success occasion. Thus, all the symbols can be considered as F before the channel is captured.

As we mentioned, in 3GPP Rel-15, SFI is carried by DCI format 2_0, and the following information is transmitted as described in clause 7.3.1.3.1 in 3GPP TS 38.212 V15.6.0:
Slot format indicator 1, Slot format indicator 2, . . . , Slot format indicator N.
   The size of DCI format 2_0 is configurable by higher layer parameter up to 128 bits.

Furthermore, as described in clause 11.1.1 in 3GPP TS 38.213 V15.6.0, each of the “Slot format indicators” or “SFI index” fields in DCI format 2_0 indicates to a UE a slot format for each slot for a period of transmission for each DL bandwidth part (BWP) or each UL BWP starting from a slot where the UE detects the DCI format 2_0. This clause applies for a serving cell that is included in a set of serving cells configured by higher layer parameter SlotFormatIndicator configuring GC-PDCCH carrying SFI, where SlotFormatIndicator is defined in 3GPP TS 38.331 as follows:

-- ASN1START
-- TAG-SLOTFORMATINDICATOR-START

| | |
|---|---|
| SlotFormatIndicator ::= | SEQUENCE { |
| sfi-RNTI | RNTI-Value, |
| dci-PayloadSize | INTEGER (1..maxSFI-DCI- |

PayloadSize),

| | |
|---|---|
| slotFormatCombToAddModList | SEQUENCE |

(SIZE(1..maxNrofAggregatedCellsPerCellGroup)) OF
SlotFormatCombinationsPerCell
OPTIONAL, -- Need N

| | |
|---|---|
| slotFormatCombToReleaseList | SEQUENCE |

(SIZE(1..maxNrofAggregatedCellsPerCellGroup)) OF ServCellIndex
OPTIONAL, -- Need N
...
}
-- TAG-SLOTFORMATINDICATOR-STOP
-- ASN1STOP

As we can see in the above IE, the UE is provided by sfi-RNTI, and the payload size of DCI format 2_0 is provided by dci-payloadSize.

Furthermore, for each serving cell in the set of serving cells indicated in SlotFormatInidcator, the UE can be provided with slotFormatCombinationsPerCell which configures the parameters used for interpretation of the field for each SFI-index for corresponding serving cell. The IE slotFormatCombinationsPerCell is defined in 3GPP TS 38.331 as follows:

| | |
|---|---|
| SlotFormatCombinationsPerCell ::= | SEQUENCE { |
| servingCellId | ServCellIndex, |
| subcarrierSpacing | SubcarrierSpacing, |
| subcarrierSpacing2 | SubcarrierSpacing |

OPTIONAL, -- Need R

| | |
|---|---|
| slotFormatCombinations | SEQUENCE (SIZE |

(1..maxNrofSlotFormatCombinationsPerSet)) OF
SlotFormatCombination
OPTIONAL, -- Need M

| | |
|---|---|
| positionInDCI | INTEGER(0..maxSFI-DCI- |
| PayloadSize-1) | OPTIONAL, -- |

Need M
...
}

| | |
|---|---|
| SlotFormatCombination ::= | SEQUENCE { |
| slotFormatCombinationId | SlotFormatCombinationId, |
| slotFormats | SEQUENCE (SIZE |

(1..maxNrofSlotFormatsPerCombination)) OF INTEGER (0..255)
}

| | |
|---|---|
| SlotFormatCombinationId ::= | INTEGER |

(0..maxNrofSlotFormatCombinationsPerSet-1)
-- TAG-SLOTFORMATCOMBINATIONSPERCELL-STOP
-- ASN1STOP

According to above IE, the following parameters are configured for each serving cell using the SlotFormatCombinationsPerCell:
An identity of the serving cell by servingCellID;
The location of SFI-index field (i.e. “slot format indicator x” in DCI format 2_0) by positionInDCI for corresponding servingCellID;
A set of slot format combinations by slotFormatCombinations which compromise of a sequence of SlotFormatCombination's. This can be interpreted as hash table where each “key” here indicated by SlotFormatCombinationID refers to a specific “slotFormatCombination” in the table, where each SlotFormatCombination includes two parameters:
   One or more slot formats (up to 256 slots) indicated by slotFormats
      The slotFormats comprise of sequence of indices form 0, . . . , 256. Each index refers to a slot format in the table 11.1.1-1 in clause 11.1.1 in 3GPP TS 38.213 as explained below;
   A mapping for the slot format combination provided by slotFormats to a corresponding SFI-index field value in DCI format 2_0 provided by the slotFormatCombinationID.

The table below from 3GPP TS 38.213 contains a list of possible slot formats. An SFI is simply an integer that takes a value from the range (0 . . . 55) or the value 255. Values in the range (56 . . . 254) are reserved for future use. Each integer value simply points to a row in the table, where each row indicates the classification for all 14 OFDM symbols of a slot.

TABLE 11.1.1-1
in 3GPP TS 38.213: Slot formats for normal cyclic prefix

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot based on TDD-UL-DL- |
| | ConfigurationCommon, or TDD-UL-DL-ConfigDedicated and, if any, on |
| | detected DCI formats |

According to above explanation, in the 3GPP specifications, DCI Format 2_0 carries SFIs for the current slot and possibly a number of future slots to a group of UEs. To limit the DCI overhead, a table of slot format combinations is pre-configured semi-statically by RRC signaling. A particular row in the table contains SFIs for up to a maximum of 256 slots. The number of slot-format combinations in the table (rows) is up to a maximum of 512. The maximal configuration for the table is illustrated in Table 1 where SFI_{m,n} is the SFI for the m^{th} slot (m^{th} column) of the n^{th} slot format combination (n^{th} row).

TABLE 1
RRC configuration of slot format combination table (maximal
configuration). Each entry in the table is an SFI pointing to a row in
Table 11.1.1-1. The maximum number of combinations is 512, and
the maximum number of slots for a given combination is 256.

| Slot Format | | | | |
|---|---|---|---|---|
| Combinations ID | Slot-0 | Slot-1 | . . . | Slot-255 |
| 0 | SFI_{0, 0} | SFI_{0, 1} | . . . | SFI_{0, 255} |
| 1 | SFI_{1, 0} | SFI_{1, 1} | . . . | |
| . | . | . | [symbol] | . |
| . | . | . | | . |
| . | . | . | | . |
| 511 | SFI_{551, 0} | SFI_{511, 1} | . . . | SFI_{511, 255} |

As explained before, DCI Format 2_0 signals (point to) a slot format combination ID (the row number in the table) for a specific serving cell in the corresponding SFI-index field. The position of the SFI-Index field for corresponding serving cell starts from the “positionInDCI” bit in the DCI configured in SlotFormatCombinationsPerCell.

Note that Table 1 shows the maximal configuration. A typical configuration may include many fewer rows and columns.

FIG. 3 illustrates an example of configuration for a serving cell with ServingCellID=3 where the positionInDCI value for this serving cell equals to 8 which means that the SFI-index for the serving cell starts at bit 8 (counting from 0). As can be seen, four slot format combinations are configured for this cell, each with a slotFormats indicating six consecutive slot patterns. This means the UE should assume a slot format combination will be indicated in the DCI by SFI-index for the next six slots from the point of detecting the GC-PDCCH carrying the DCI. In the illustrated example, the DCI is indicating the last slotFormatCombination in the SlotFormatCombinations which is indicated by slotFormatCombinationID=3; therefore, the SFI index corresponds to bit values “11” and the DCI becomes xxxxxx11xx . . . (here x's are set by SFI-indices for other serving cells).

For a node (e.g., NR in Unlicensed spectrum (NR-U) gNB/UE, LTE-LAA eNB/UE, or WiFi AP/STA) to be allowed to transmit in unlicensed spectrum (e.g., 5 GHz band), the node typically needs to perform a clear channel assessment (CCA). This procedure typically includes sensing the medium to be idle for a number of time intervals. Sensing the medium to be idle can be done in different ways, e.g. using energy detection, using preamble detection, or using virtual carrier sensing. The latter implies that the node reads control information from other transmitting nodes informing it of when a transmission ends. After sensing the medium to be idle, the node is typically allowed to transmit for a certain amount of time, sometimes referred to as transmission opportunity (TXOP). The length of the TXOP depends on regulation and type of CCA that has been performed, but typically ranges from 1 ms to 10 ms. This duration is often referred to as a COT (Channel Occupancy Time). See, for example, tables 4.1.1-1 and 4.2.1-1 in 3GPP TS 37.213 V15.2.0.

In Wi-Fi, feedback of data reception acknowledgements (ACKs) is transmitted without performing CCA. Preceding feedback transmission, a small duration, which is called a short inter-frame space (SIFS), is introduced between the data transmission and the corresponding feedback which does not include actual sensing of the channel. In IEEE 802.11, the SIFS period (16 μs for 5 GHz OFDM PHYs) is defined as:

aSIFSTime=aRxPHYDelay+aMACProcessingDelay+aRxTxTurnaroundTime where:
aRxPHYDelay defines the duration needed by the PHY layer to deliver a packet to the MAC layer,
aMACProcessingDelay defines the duration that the MAC layer needs to trigger the PHY layer transmitting a response, and
aRxTxTurnaroundTime defines the duration needed to turn the radio from reception into transmit mode.
   Therefore, the SIFS duration is used to accommodate for the hardware delay to switch the direction from reception to transmission.

In NR-U, a similar gap to accommodate for the radio turnaround time will be allowed. This will enable the transmission of Physical Uplink Control Channel (PUCCH) carrying Uplink Control Information (UCI) feedback as well as PUSCH carrying data and possible UCI within the same TXOP acquired by the initiating gNB. For example, the UE can transmit feedback without performing CCA before PUSCH/PUCCH transmission as long as the gap between DL and UL transmission is less than or equal to 16 μs. When the gap between DL and UL is larger than 25 μs, the UE can transmit feedback after 25 μs CCA is successful. Operation in this manner is typically called “COT sharing.”

FIG. 4 illustrates a TXOP both with and without COT sharing after CCA is successful at the gNB.

As for NR in licensed bands, it is expected that NR-U will support transmission over a wide bandwidth (»20 MHz). Related to this, the following objective is listed in the NR-U Work Item Description (WID) (RP-182878, “New WID on NR-based Access to Unlicensed Spectrum,” Qualcomm, RAN#82, December 2018.):
Wide band operation (in integer mu/tip/es of 20MHz) for DL and UL for NR-U supported with multiple serving cells, and wideband operation (in integer mu/tip/es of 20 MHz) for DL and UL for NR-U supported with one serving cell with bandwidth >20MHz with potential scheduling constraint subject to input from RAN2 and RAN4 on feasibility of operating the wideband carrier when LBT is unsuccessful in one or more LBT subbands within the wideband carrier. For all wide-band operation cases, CCA is performed in units of 20 MHz (at least for 5 GHz).

The common understanding in RAN1 is that this may be achieved through either of the following approaches: single serving cell of bandwidth >20 MHz or aggregation of multiple serving cells of bandwidth 20 MHz or greater. It is also stated that CCA is performed in units of 20 MHz (at least for 5 GHz). This is referred to as the LBT bandwidth (LBW).

NR-U wide band operation allows for carrier aggregation of multiple serving cells with each serving cell mapped to a 20 MHz LBW (Wideband Mode 1). The gNB and UE behaviors in this operation mode have been specified as carrier aggregation in NR Rel-15.

NR-U wide band operation allows for transmission/receptions on parts or whole of the BWP of a wideband carrier depending on LBT outcome (Wideband Mode 2). For example, if an 80 MHz BWP is configured within a wideband carrier and LBW=20 MHz, the carrier consists of 4 LBT sub-bands. In principle, any combination of 1, 2, 3, or 4 sub-bands may be available depending on the LBT outcome. This is illustrated in FIG. 5 (Wideband Mode 2 for the case of a single 80 MHz carrier—Various channel puncturing scenarios based on LBT outcome are illustrated). This type of operation is referred to herein as “Channel Puncturing,” since depending on LBT outcome, some subset of the 20 MHz sub-bands (corresponding to 20 MHz channels) are not available for transmission/reception, i.e., are punctured.

In the 3GPP RAN1 #97 meeting the following agreement was reached (see “RAN1 Chairman's Notes”, 3GPP RAN WG1 meeting #97, Reno, USA, May 2019):
Agreement:
When GC-PDCCH is configured, explicit indication via GC-PDCCH is supported as a mechanism to inform the UE that one or more carriers and/or LBT bandwidths are not available or available for DL reception, at least for slot(s) that are not at the beginning of DL transmission burst.
   FFS: Signalling details of the indication, including e.g., the time domain validity of the indication
   FFS: Whether and how to support the mechanism at the beginning of DL transmission burst
FFS: Whether and how to handle the case when GC-PDCCH is not configured or not received by the UE

There currently exist certain challenge(s). In NR Rel-15 DCI format 2_0 is used for indication of the transmission direction per symbol in the time domain for up to 256 slots periodically. As explained above, the time domain slot format indicator is carried in DCI by corresponding bits for each serving cell. However, besides this, there is no other information being transmitted regarding the structure or status of the transmission in the frequency domain, i.e., availability of LBT bandwidths for a serving cell. It has been agreed in 3GPP that a mechanism is introduced to indicate the LBW availability in GC-PDCCH. However, the details of how to indicate this information have not been determined.

### SUMMARY

Systems and methods are disclosed herein for indicating availability of a resource block sets within a cellular communications system. Embodiments of a method performed by a wireless communication device for a cellular communications system are disclosed. In one embodiment, the method comprises receiving serving cell configurations for the one or more configured serving cells of the wireless communication device. The one or more configured serving cells are one or more configured serving cells of the wireless communication device that require Listen-Before-Talk (LBT). The method further comprises receiving a Downlink Control Information (DCI) from a network node. The DCI comprises one or more slot format combination indications for one or more configured serving cells of the wireless communication device, wherein each slot format combination indication from among the one or more slot format combination indications is an indication of one or more slot formats for one or more slots on at least one respective configured serving cell from among the one or more configured serving cells of the wireless communication device. The DCI further comprises one or more Resource Block (RB) set indications for the one or more configured serving cells of the wireless communication device, wherein each RB set indication from among the one or more RB set indications comprises one or more bits that indicate availability of one or more RB sets for at least one respective configured serving cell from among the one or more configured serving cells of the wireless communication device. The method further comprises decoding the DCI based on the serving cell configurations. A format of the DCI is such that the one or more slot format combination indications are comprised in a first set of bits in the DCI and the one or more RB set indications are comprised in a second set of bits in the DCI. In this manner, a highly generic, flexible, and efficient solution for indicating serving cells and RB set availability is provided.

In one embodiment, the method further comprises performing one or more operational tasks in accordance with the received DCI.

In one embodiment, the second set of bits are located in bit positions within the DCI that are all after a bit position of a last bit of the first set of bits within the DCI.

In one embodiment, decoding the DCI based on the serving cell configurations comprises identifying starting positions of the slot format combination indications in the DCI based on the serving cell configurations.

In one embodiment, decoding the DCI based on the serving cell configurations comprises identifying starting positions of the RB set indications in the DCI based on one or more RRC parameters.

In one embodiment, the serving cell configurations comprise, for each serving cell from among the one or more configured serving cells of the wireless communication device, a Radio Resource Control (RRC) parameter that indicates a location of a respective one of the one or more RB set indications for the configured serving cell in the DCI. In one embodiment, the RRC parameter is a parameter positionInDCI comprised in a field in a SlotFormatIndicator Information Element (IE).

In one embodiment, the serving cell configurations comprise, for at least one of the one or more configured serving cells, an indication of the number of RB sets within a total bandwidth of the serving cell.

In one embodiment, for each RB set indication from among the one or more RB set indications, the one or more bits comprised in the RB set indication are associated to the one or more respective RB sets for the at least one respective configured serving cell in sequential order.

In one embodiment, for each RB set indication from among the one or more RB set indications, the one or more bits comprised in the RB set indication are associated to the one or more respective RB sets for the at least one respective configured serving cell via RRC parameters.

In one embodiment, the DCI comprises one slot format combination indication and one RB set indication per configured serving cell. In one embodiment, the slot format combination indication is an indication of a combination of one or more slot formats that define slot formats for a plurality of slots of a configured serving cell from among the one or more configured service cells of the wireless communication device.

In one embodiment, the one or more configured serving cells comprise two or more configured serving cells, the DCI comprises one slot format combination indication per configured serving cell, and at least two of the two or more configured serving cells share a same RB set indication.

In one embodiment, the one or more configured serving cells comprise two or more configured serving cells, the DCI comprises one RB set indication per configured serving cell, and at least two of the two or more configured serving cells share a same slot format combination indication.

In one embodiment, the DCI further comprises, for at least one of the one or more RB sets for at least one of the one or more configured serving cells, a parameter that indicates an end of channel occupancy for the configured serving cell for the at least one of the one or more RB sets.

In one embodiment, the DCI further comprises, for at least one of the one or more RB sets for at least one of the one or more configured serving cells, one or more of the following parameters: a Channel Occupancy Time (COT) sharing indication and a parameter that indicates a Listen-Before-Talk (LBT) type or category for uplink transmissions.

In one embodiment, receiving the DCI comprises receiving the DCI on a Group Common Physical Downlink Control Channel (GC-PDCCH). In one embodiment, receiving the DCI on the GC-PDCCH comprises receiving the DCI on the GC-PDCCH in accordance with DCI format 2_0.

In one embodiment, the one or more configured serving cells are one or more New Radio in Unlicensed spectrum (NR-U) cells. In one embodiment, the one or more configured serving cells operate in accordance with a Time Division Duplexing (TDD) scheme.

In one embodiment, the one or more operational tasks comprise receiving a downlink transmission taking into consideration availability of LBT bandwidths of the one or more configured serving cells as indicated by one or more LBT bandwidth indications for the one or more configured serving cells.

In one embodiment, the one or more operational tasks comprise transmitting an uplink transmission taking into consideration availability of LBT bandwidths of the one or more configured serving cells as indicated by one or more LBT bandwidth indications for the one or more configured serving cells.

Corresponding embodiments of a wireless communication device are also disclosed. In one embodiment, a wireless communication device is adapted to receive serving cell configurations for the one or more configured serving cells of the wireless communication device, where the one or more configured serving cells are one or more configured serving cells of the wireless communication device that require LBT. The wireless communication device receives a DCI from a network node. The DCI comprises one or more slot format combination indications for one or more configured serving cells of the wireless communication device, wherein each slot format combination indication from among the one or slot format combination indications is an indication of one or more slot formats for one or more slots on at least one respective configured serving cell from among the one or more configured serving cells of the wireless communication device. The DCI further comprises one or more RB set indications for the one or more configured serving cells of the wireless communication device, wherein each RB set indication from among the one or more RB set indications comprises one or more bits that indicate availability of one or more RB sets for at least one respective configured serving cell from among the one or more configured serving cells of the wireless communication device. The wireless communication device is further adapted to decode the DCI based on the serving cell configurations. A format of the DCI is such that the one or more slot format combination indications are comprised in a first set of bits in the DCI and the one or more RB set indications are comprised in a second set of bits in the DCI.

In another embodiment, a wireless communication device comprises one or more transmitters, one or more receivers, and processing circuitry associated with the one or more transmitters and the one or more receivers. The processing circuitry is configured to cause the wireless communication device to receive serving cell configurations for the one or more configured serving cells of the wireless communication device, wherein the one or more configured serving cells are one or more configured serving cells of the wireless communication device that require LBT. The processing circuitry is further configured to cause the wireless communication device to receive a DCI from a network node. The DCI comprises one or more slot format combination indications for one or more configured serving cells of the wireless communication device, wherein each slot format combination indication from among the one or slot format combination indications is an indication of one or more slot formats for one or more slots on at least one respective configured serving cell from among the one or more configured serving cells of the wireless communication device. The DCI further comprises one or more RB set indications for the one or more configured serving cells of the wireless communication device, wherein each RB set indication from among the one or more RB set indications comprises one or more bits that indicate availability of one or more RB sets for at least one respective configured serving cell from among the one or more configured serving cells of the wireless communication device. The processing circuitry is configured to cause the wireless communication device to decode the DCI based on the serving cell configuration. A format of the DCI is such that the one or more slot format combination indications are comprised in a first set of bits in the DCI and the one or more RB set indications are comprised in a second set of bits in the DCI.

Embodiments of a method performed by a network node for a cellular communications system are also disclosed. In one embodiment, the method comprises transmitting or initiating transmission of, to a wireless communication device, serving cell configurations for one or more configured serving cells of the wireless communication device, wherein the one or more configured serving cells being one or more configured serving cells of the wireless communication device that require LBT. The method further comprises transmitting or initiating transmission of a DCI to the wireless communication device. The DCI comprises one or more slot format combination indications for one or more configured serving cells of the wireless communication device, wherein each slot format combination indication from among the one or slot format combination indications is an indication of one or more slot formats for one or more slots on at least one respective configured serving cell from among the one or more configured serving cells of the wireless communication device. The DCI further comprises one or more RB set indications for the one or more configured serving cells of the wireless communication device, wherein each RB set indication from among the one or more RB set indications comprises one or more bits that indicate availability of one or more RB sets for at least one respective configured serving cell from among the one or more configured serving cells of the wireless communication device. A format of the DCI is such that the one or more slot format combination indications are comprised in a first set of bits in the DCI and the one or more RB set indications are comprised in a second set of bits in the DCI.

In one embodiment, the second set of bits are located in bit positions within the DCI that are all after a bit position of a last bit of the first set of bits within the DCI.

In one embodiment, the serving cell configurations comprise, for each serving cell from among the one or more configured serving cells of the wireless communication device, a RRC parameter that indicates a location of a respective one of the one or more RB set indications for the configured serving cell in the DCI. In one embodiment, the RRC parameter is a parameter positionInDCI comprised in a field in a SlotFormatIndicator IE.

In one embodiment, the serving cell configurations comprise, for at least one of the one or more configured serving cells, an indication of a number of RB sets within a total bandwidth of the serving cell.

In one embodiment, for each RB set indication from among the one or more RB set indications, the one or more bits comprised in the RB set indication are associated to the one or more respective RB sets for the at least one respective configured serving cell in sequential order.

In one embodiment, for each RB set indication from among the one or more RB set indications, the one or more bits comprised in the RB set indication are associated to the one or more respective RB sets for the at least one respective configured serving cell via RRC parameters.

In one embodiment, the DCI comprises one slot format combination indication and one RB set indication per configured serving cell.

In one embodiment, the one or more configured serving cells comprise two or more configured serving cells, the DCI comprises one slot format combination indication per configured serving cell, and at least two of the two or more configured serving cells share a same RB set indication.

In one embodiment, the one or more configured serving cells comprise two or more configured serving cells, the DCI comprises one RB set indication per configured serving cell, and at least two of the two or more configured serving cells share a same slot format combination indication.

In one embodiment, the DCI further comprises, for at least one of the one or more RB sets for at least one of the one or more configured serving cells, a parameter that indicates an end of channel occupancy for the configured serving cell for the at least one of the one or more RB sets.

In one embodiment, the DCI further comprises, for at least one of the one or more RB sets for at least one of the one or more configured serving cells, one or more of the following parameters: a COT sharing indication and a parameter that indicates a LBT type or category for uplink transmissions.

In one embodiment, transmitting or initiating transmission of the DCI comprises transmitting or initiating transmission of the DCI on a GC-PDCCH.

In one embodiment, transmitting or initiating transmission of the DCI on the GC-PDCCH comprises transmitting or initiating transmission of the DCI on the GC-PDCCH in accordance with DCI format 2_0.

In one embodiment, the one or more configured serving cells are one or more NR-U cells.

Corresponding embodiments of a network node are also disclosed. In one embodiment, a network node is adapted to transmit or initiate transmission of, to a wireless communication device, serving cell configurations for one or more configured serving cells of the wireless communication device, wherein the one or more configured serving cells are one or more configured serving cells of the wireless communication device that require LBT. The network node is further adapted to transmit or initiate transmission of a DCI to the wireless communication device. The DCI comprises one or more slot format combination indications for one or more configured serving cells of the wireless communication device, wherein each slot format combination indication from among the one or slot format combination indications is an indication of one or more slot formats for one or more slots on at least one respective configured serving cell from among the one or more configured serving cells of the wireless communication device. The DCI further comprises one or more RB set indications for the one or more configured serving cells of the wireless communication device, wherein each RB set indication from among the one or more RB set indications comprises one or more bits that indicate availability of one or more RB sets for at least one respective configured serving cell from among the one or more configured serving cells of the wireless communication device. A format of the DCI is such that the one or more slot format combination indications are comprised in a first set of bits in the DCI and the one or more RB set indications are comprised in a second set of bits in the DCI.

In another embodiment, a network node comprises processing circuitry configured to cause the network node to transmit or initiate transmission of, to a wireless communication device, serving cell configurations for one or more configured serving cells of the wireless communication device, wherein the one or more configured serving cells are one or more configured serving cells of the wireless communication device that require LBT. The processing circuitry is further configured to cause the network node to transmit or initiate transmission of a DCI to the wireless communication device. The DCI comprises one or more slot format combination indications for one or more configured serving cells of the wireless communication device, wherein each slot format combination indication from among the one or slot format combination indications is an indication of one or more slot formats for one or more slots on at least one respective configured serving cell from among the one or more configured serving cells of the wireless communication device. The DCI further comprises one or more RB set indications for the one or more configured serving cells of the wireless communication device, wherein each RB set indication from among the one or more RB set indications comprises one or more bits that indicate availability of one or more RB sets for at least one respective configured serving cell from among the one or more configured serving cells of the wireless communication device. A format of the DCI is such that the one or more slot format combination indications are comprised in a first set of bits in the DCI and the one or more RB set indications are comprised in a second set of bits in the DCI.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the basic New Radio (NR) physical resource over an antenna port represented as a time-frequency grid of Resource Blocks (RBs);

FIG. 2 illustrates a few exemplary cell-specific Time Division Duplexing (TDD) patterns that are semi-statically configured using the current configuration scheme in NR;

FIG. 3 illustrates an example of configuration for a serving cell with ServingCellID=3 where positionInDCI value for the serving cell equals to 8 which means that Slot Format Indicator (SFI) index for the serving cell starts at bit 8 (counting from 0) in the Downlink Control Information (DCI);

FIG. 4 illustrates a Transmit Opportunity (TXOP) both with and with Channel Occupancy Time (COT) sharing;

FIG. 5 illustrates various channel puncturing scenarios based on Listen Before Talk (LBT) outcome for a single 80 Megahertz (MHz) carrier that consists of four LBT sub-bands;

FIG. 6 illustrates one example of a cellular communications system in which embodiments of the present disclosure may be implemented;

FIG. 7 illustrates two examples of DCI Format 2-0 with one SFI-index and one LBT bandwidth (LBW) bit-field per serving cell in accordance with a first embodiment of the present disclosure;

FIG. 8 illustrates two examples of DCI Format 2_0 with SFI-index sharing in accordance with a second embodiment of the present disclosure;

FIG. 9 illustrates two examples of DCI Format 2_0 with SFI-index and LBW-index sharing in accordance with a third embodiment of the present disclosure;

FIG. 10 illustrates the operation of a base station and a wireless communication device in accordance with at least some aspects of various embodiments of the present disclosure;

FIGS. 11 through 13 are schematic block diagrams of example embodiments of a radio access node;

FIGS. 14 and 15 are schematic block diagrams of example embodiments of a wireless communication device or User Equipment (UE);

FIG. 16 illustrates an example embodiment of a communication system in which embodiments of the present disclosure may be implemented;

FIG. 17 illustrates example embodiments of the host computer, base station, and UE of FIG. 16; and

FIGS. 18 through 21 are flow charts that illustrate example embodiments of methods implemented in a communication system such as that of FIG. 16.

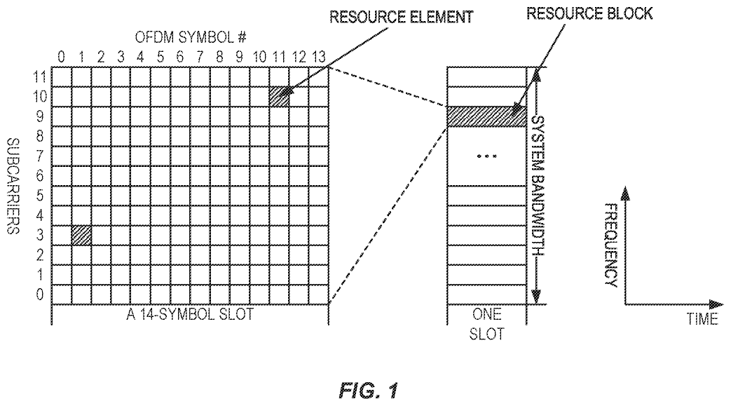

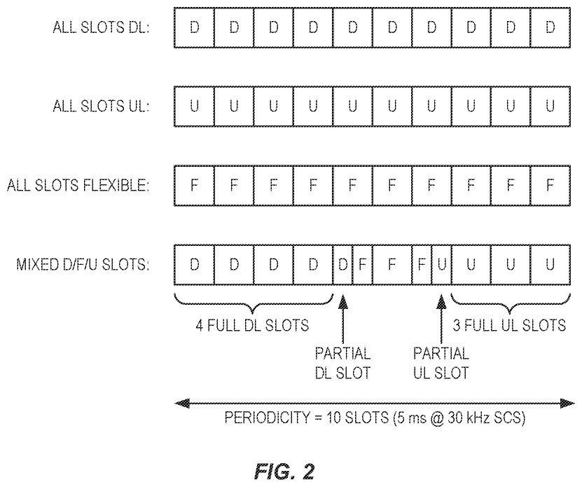

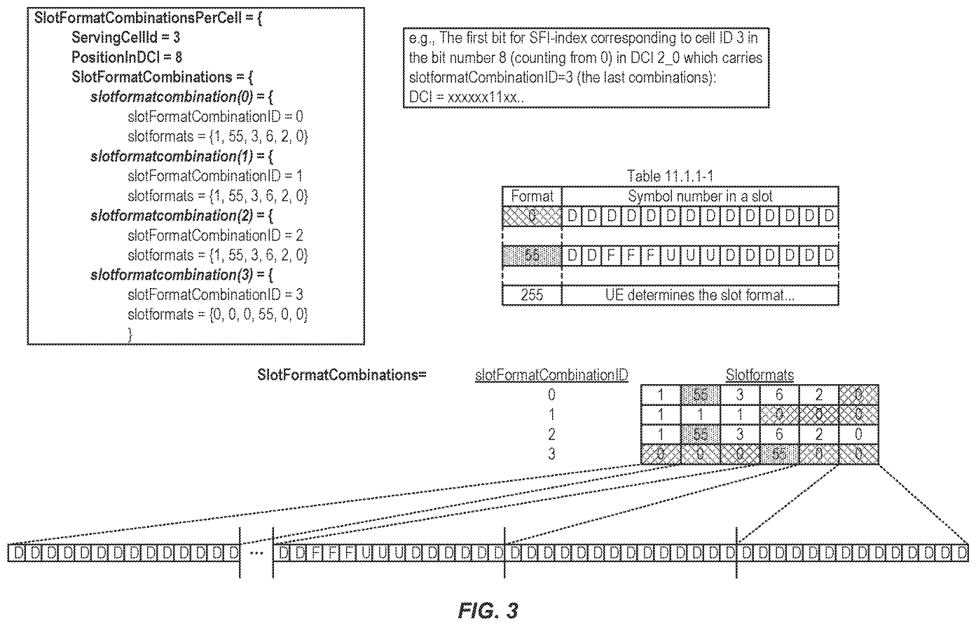

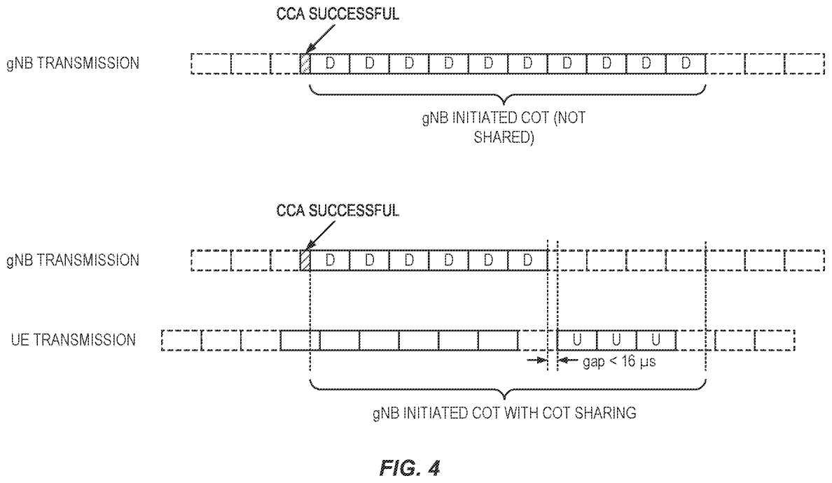

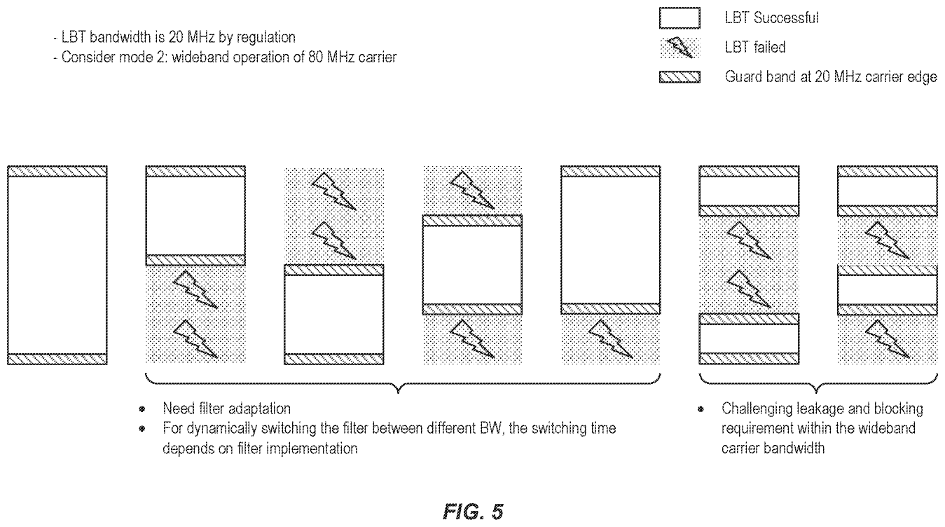

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

As discussed above, there currently exist certain challenge(s) in relation to dynamic Time Division Duplexing (TDD) in 5G NR. In NR Release 15, Downlink Control Information (DCI) format 2_0 is used for indication of the transmission direction per symbol in the time domain for up to 256 slots periodically. As explained above, the time domain slot format indicator (SFI) is carried in DCI by corresponding bits for each serving cell. However, besides this, there is no other information being transmitted regarding the structure or status of the transmission in the frequency domain, i.e., availability of Listen Before Talk (LBT) bandwidths (LBWs) for a serving cell. It has been agreed in 3GPP that a mechanism is introduced to indicate the LBW availability in Group Common Physical Downlink Control Channel (GC-PDCCH) which carries DCI in DCI format 2_0. However, the details of how to indicate this information has not been determined.

3GPP contribution R1-1907259 entitled “DL signals and channels for NR-U” proposed that “NR SFI can be enhanced to support the functionality of LTE-LAA C-PDCCH and support band based channel access.” This contribution further states that this proposed enhancement include “a bitmap to indicate which sub-bands/carriers are acquired by the gNB” and “information of remaining COT duration in number of symbols.” However, no further details were given about how such bitmap and information would be signaled.

The LBW availability indication mechanism should leverage the SFI signaling mechanism in NR Rel-15 as much as possible, to reduce the standardization and implementation complexity. The mechanism should also be generic and flexible enough to support NR operation in licensed and unlicensed bands and support both NR wideband operation in unlicensed bands both for carriers with bandwidth equal to the LBW and for carriers with bandwidth consisting of multiple LBWs. Further, considering the potentially large number of serving cells and LBWs in the case of NR-U wideband operation, it is important that the LBW indication mechanism is highly efficient to keep the DCI Format 2_0 payload size low.

Certain aspects of the present disclosure and their embodiments may provide solutions to the aforementioned or other challenges. Systems and methods are disclosed herein for signaling an indication of availability of serving cells and/or LBWs in a DCI transmitted on a downlink control channel, which in the examples described herein is DCI transmitted on the GC-PDCCH using DCI Format 2_0. In particular, example embodiments include one or more of the following aspects:
DCI Format 2_0 is extended to carry an LBW bit field for each configured serving cell, indicating the availability of the configured LBWs for the serving cell.
gNB provides dedicated Radio Resource Control (RRC) configuration to UEs to specify the number of LBWs and their bit-field positions in DCI Format 2_0 for each configured serving cell.
Slot formats for multiple serving cells can be indicated with the same SFI-index in DCI Format 2_0 to reduce the DCI payload, wherein the SFI-index points to a slot format combination provided by slotFormats by slotFormatCombinationId.

Being developed based on SFI signaling framework in NR Rel-15, embodiments disclosed herein provide a highly generic, flexible, and efficient solution for indicating serving cells and LBWs availability to a group of UEs. Embodiments disclosed herein provide a highly generic, flexible, and efficient solution for indicating serving cells and LBWs availability to a group of UEs in NR-U wideband operation with limited specification impact. Note, however, as described herein, the solutions are not limited to NR-U.

Certain embodiments may provide one or more of the following technical advantage(s). Embodiments of the present disclosure provide a highly generic, flexible, and efficient solution for indicating serving cells and LBWs availability to a group of UEs in NR-U wideband operation with limited specification impact. Embodiments include one or more of the following aspects:
ability to provide the same SFI information to multiple serving cell while addressing the LBW availability separately for the same cells;
extension of the already existing RRC parameter for configuration of the DCI format 2_0;
a configurable number of bits in DCI for addressing the LBW availability per cell based on the network configuration.

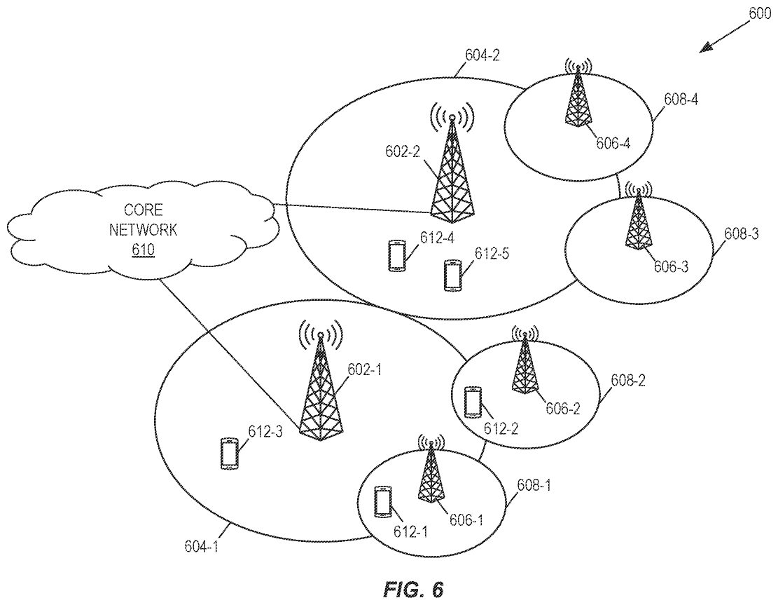

In this regard, FIG. 6 illustrates one example of a cellular communications system 600 in which embodiments of the present disclosure may be implemented. In the embodiments described herein, the cellular communications system 600 is a 5G system (5GS) including a NR RAN or LTE RAN (i.e., E-UTRA RAN) or an Evolved Packet System (EPS) including a LTE RAN; however, the present disclosure is not limited thereto. In this example, the RAN includes base stations 602-1 and 602-2, which in LTE are referred to as eNBs (when connected to EPC) and in 5G NR are referred to as gNBs ng-eNBs, controlling corresponding (macro) cells 604-1 and 604-2. The base stations 602-1 and 602-2 are generally referred to herein collectively as base stations 602 and individually as base station 602. Likewise, the (macro) cells 604-1 and 604-2 are generally referred to herein collectively as (macro) cells 604 and individually as (macro) cell 604. The RAN may also include a number of low power nodes 606-1 through 606-4 controlling corresponding small cells 608-1 through 608-4. The low power nodes 606-1 through 606-4 can be small base stations (such as pico or femto base stations) or Remote Radio Heads (RRHs), or the like. Notably, while not illustrated, one or more of the small cells 608-1 through 608-4 may alternatively be provided by the base stations 602. The low power nodes 606-1 through 606-4 are generally referred to herein collectively as low power nodes 606 and individually as low power node 606. Likewise, the small cells 608-1 through 608-4 are generally referred to herein collectively as small cells 608 and individually as small cell 608. The cellular communications system 600 also includes a core network 610, which in the 5GS is referred to as the 5G core (5GC). The base stations 602 (and optionally the low power nodes 606) are connected to the core network 610.

The base stations 602 and the low power nodes 606 provide service to wireless communication devices 612-1 through 612-5 in the corresponding cells 604 and 608. The wireless communication devices 612-1 through 612-5 are generally referred to herein collectively as wireless communication devices 612 and individually as wireless communication device 612. In the following description, the wireless communication devices 612 are oftentimes UEs, but the present disclosure is not limited thereto.

At least some of the cells 604 and/or 608 are in unlicensed spectrum. Specifically, in the example embodiments described herein, at least some of the base stations 602 and/or low power nodes 606 operate at some of the cells 604 and/or 608 in the unlicensed spectrum in accordance with NR-U.

Some example embodiments will now be described. While described under separate headings, these embodiments may be used separately or in any desired combination unless explicitly stated or otherwise required.

### Embodiment #1: Extension of DCI Format 2_0 to Support LBW Indication

The DCI Format 2_0 in NR Rel-15 is extended with an LBW indicator field which consists of several LBW bit-fields, one per configured serving cell. The widths of the bit-fields are equal to the numbers of the LBWs in the corresponding serving cells as configured by the higher layer. Each bit in a bit-field indicates the availability for the corresponding LBW. The association of bits in the LBW bit-field with configured LBWs are in sequential order. For example, Bit 0 associates with LBW 0, Bit 1 with LBW 1, and so on.

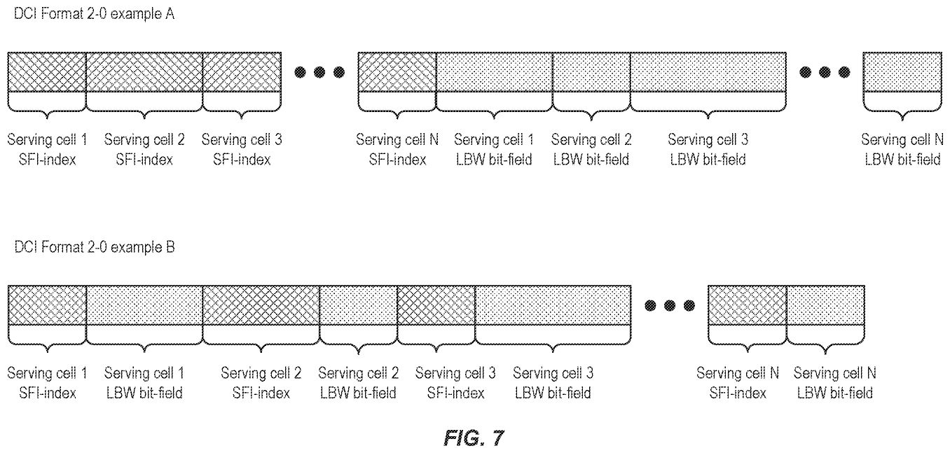

FIG. 7 illustrates two exemplary realizations of the SFI-index and LBW indicator multiplexing in DCI Format 2_0. In other words, FIG. 7 illustrates examples of DCI Format 2-0 with one SFI-index and one LBW bit-field per serving cell. In example A in the figure, DCI Format 2_0 starts with a list of SFI-index, followed by a list of LBW bit-fields. In example B, DCI Format 2_0 is constructed as a list of {SFI-Index, LBW-bit-field} pairs. In general, the LBW bit-fields corresponding to different serving cells can have different width as shown in the diagram, implying that different serving cells consist of different number of LBT bandwidths.

In a variation of this embodiment, the availability is applied to set of contiguous/or non-contiguous PRBs. As should be understood by one of skill in the art upon reading this disclosure, the set of contiguous or non-contiguous PRBs is a set of contiguous or non-contiguous PRBs in the frequency domain, in a manner similar to LBWs or sub-bands.

Embodiment #1.1: In a variation of Embodiment 1, the association of the bits in each LBW bit field is configured by RRC parameters (as oppose to sequential indication). A sequence corresponding to each LBW is defined, each entry indicates the position of the bit in the DCI for corresponding LBW.

### Embodiment #2: Multiple Serving Cells Sharing the Same SFI in DCI Format 2_0

In some implementation cases, the same TDD pattern, i.e., DL or UL allocation of time resource, needs to be used among multiple carriers (serving cells) for reasons such as radio frequency components sharing, interference mitigation, and so on. When this is the case, the same SFI is indicated for those serving cells with the same TDD pattern.

The fact that multiple serving cells share the same SFI statically or semi-statically can be utilized to optimize the DCI Format 2_0 overhead for SFI indication. In NR Rel-15, the starting position (in number of bits) of the SFI-index in DCI Format 2_0 for a serving cell is indicated by positionInDCI field in the SlotFormatCombinationsPerCell IE (see 3GPP TS 38.331), which does not prevent the gNB from indicating the same SFI-index in DCI Format 2_0 for multiple serving cells with the same posistionInDCI value as long as they share the same TDD pattern. By doing this, the payload size for DCI Format 2_0 can be reduced. This is an optimization usage of the current Rel-15 NR specification that can benefit NR operation in both licensed and unlicensed bands. Note, however, that these two fields (i.e., TDD pattern and LBT bandwidth/RB-set availability) need not to be necessarily tied together, i.e. TTD pattern should not necessarily determine the LBT bandwidth/RB-set availability or vice versa. Also, the two fields are configurable, so one can be present in the DCI while the other is absent.

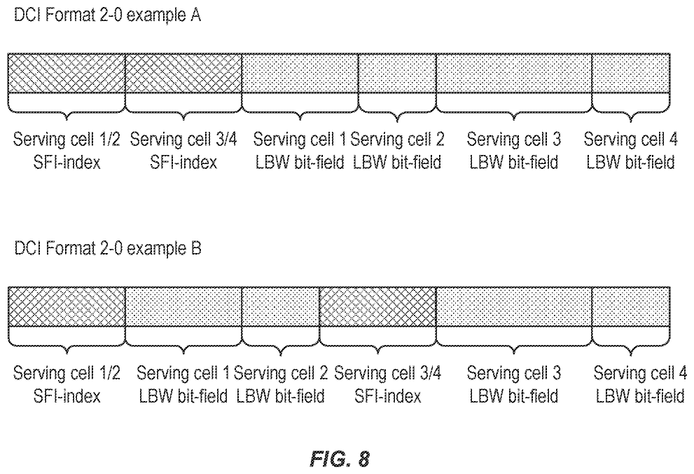

An exemplary implementation of the embodiment is illustrated in FIG. 8. In other words, FIG. 8 illustrates examples of DCI Format 2_0 with SFI-index sharing. Assuming a UE is configured with four serving cells (serving cells 1, 2, 3, and 4), among which serving cells 1 and 2 share the same SFI-index and serving cells 3 and 4 share the same SFI-index, positionInDCIs for serving cells 1 and 2 can both point to the first SFI-index, while positionInDCIs for serving cells 3 and 4 can both point to the second SFI-index in DCI Format 2_0. The positions of SFI-indices and LBW bit-fields in the DCI are configured by RRC.

In a variation of this embodiment, the availability is applied to set of contiguous/or non-contiguous PRBs. Again, as should be understood by one of skill in the art upon reading this disclosure, the set of contiguous or non-contiguous PRBs is a set of contiguous or non-contiguous PRBs in the frequency domain, in a manner similar to LBWs or sub-bands.

### Embodiment #3: Multiple Serving Cells Sharing the Same LBW in DCI Format 2_0

In some simplified LBT implementation cases, a node performs LBT over a bandwidth that covers more than one serving cell. When this is the case, the same LBW can be indicated for those serving cells with the same TDD pattern.

The fact that multiple serving cells share the same LBW statically or semi-statically can be utilized to minimize the DCI Format 2_0 overhead for LBW indication. This can be achieved by assigning the same positionInDCI field in the subbandUtilizationsPerCell-r16 IE (proposed in Embodiment #4 below) for the serving cells covered by the same LBT operation.

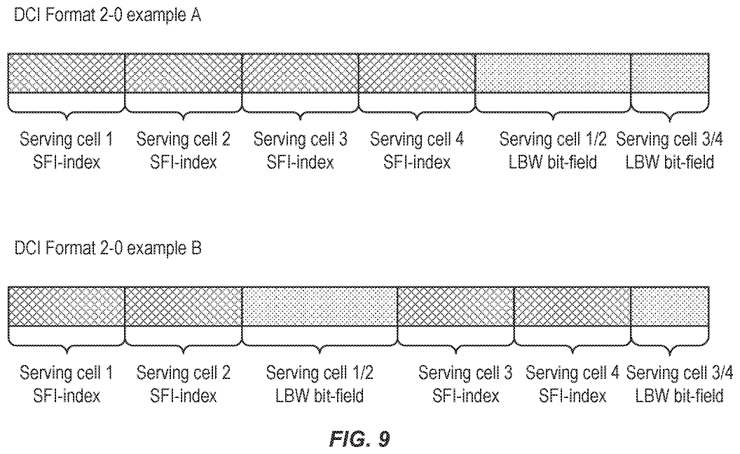

An exemplary implementation of the embodiment is illustrated in FIG. 9. In other words, FIG. 9 illustrates examples of DCI Format 2_0 with SFI-index and LBW-index sharing. Assuming a UE is configured with four serving cells (serving cells 1, 2, 3, and 4), among which serving cells 1 and 2 share the same LBW index/field and serving cells 3 and 4 share the same LBW index/field, positionInDCIs in subbandUtilizationsPerCell-r16 for serving cells 1 and 2 can both point to the first LBW-index, while positionInDCIs for serving cells 3 and 4 can both point to the second LBW-index in DCI Format 2_0. The positions of LBW-indices and LBW bit-fields in the DCI are configured by RRC.

### Embodiment #4: RRC Configuration Extension with LBW Configuration

In a non-limiting, exemplary realization of the above, a new field, subbandUtilizationsPerCell-r16, is introduced to the existing SlotFormatIndicator IE in RRC as proposed by the exemplary ASN.1 below (IE updates are highlighted in bold and italicized lettering):

| | |
|---|---|
| SlotFormatIndicator ::= | SEQUENCE { |
| sfi-RNTI | RNTI-Value, |
| dci-PayloadSize | INTEGER (1..maxSFI-DCI- |

PayloadSize),

| | |
|---|---|
| slotFormatCombToAddModList | SEQUENCE |

(SIZE(1..maxNrofAggregatedCellsPerCellGroup)) OF
SlotFormatCombinationsPerCell

OPTIONAL,

-- Need N

| | |
|---|---|
| slotFormatCombToReleaseList | SEQUENCE |

(SIZE(1..maxNrofAggregatedCellsPerCellGroup)) OF

| | |
|---|---|
| ServCellIndex | OPTIONAL, -- Need N |

subbandUtilToAddModList-r16 SEQUENCE
(SIZE(1..maxNrofAggregatedCellsPerCellGroup)) OF
subbandUtilizationsPerCell-r16

OPTIONAL,

-- Need N
subbandUtilToReleaseList SEQUENCE
(SIZE(1..maxNrofAggregatedCellsPerCellGroup)) OF

| | |
|---|---|
| ServCellIndex | OPTIONAL, -- Need N |

...
}

| | |
|---|---|
| subbandUtilizationsPerCell-r16 ::= | SEQUENCE { |
| servingCellId | ServCellIndex, |
| nrofSubbands | INTEGER(2..maxNrofSubbandsP |
| erCell), | OPTIONAL |
| positionInDCI | INTEGER(0..maxSFI-DCI- |
| PayloadSize-1) | OPTIONAL, -- |

Need M
}

subbandUtilizationsPerCell-r16 field descriptions

servingCellId
The ID of the serving cell for which the slotFormatCombinations
are applicable.
nrofSubbands
The number of LBT subband for the serving cell. If the field is not
provided, nrofSubbands equals to one.
positionInDCI
The (starting) position (bit) of the LBW availability bit-field for this
serving cell (servingCellId) within the DCI payload (see TS 38.213 [13],
clause 11.1.1).

As can be seen in the above realization example, the existing SlotFormatIndicator IE can be extended with serving cell specific subband utilization configurations, which is equivalent to LBW availability.

A subband utilization configuration indicates to the UE how many LBT bandwidths are configured in the corresponding serving cell (nrofSubbands). This field can be absent from the subband configuration if there is only one LBT bandwidth in the serving cell. A subband configuration can also indicate the position in DCI Format 2_0 (positionInDCI) where the LBW availability bit-field is located. Given the number of subbands and the bit-field positions, a UE can extract the LBW availability information from DCI Format 2_0.

In another embodiment, the configuration of the number of subbands for a serving cell and the LBW bit-field positions in DCI Format 2_0 is not provided explicitly in the SlotFormatIndicator IE. Instead, this information can be derived from the frequency resource (LBT bandwidth) configuration and the SlotFormatIndicator IE. Given the number of LBWs in a serving cell and the predefined DCI Format 2_0 multiplexing rules, it is possible for the UE to determine the exact locations of the LBW availability bit-fields in DCI Format 2-0.

In a variation of this embodiment, the configuration of the number of subbands for a serving cell (nrofSubbands) is not provided explicitly in the SlotFormatIndicatorIE. Instead it is provided in a separately configured RRC parameter, for example, in a parameter that defines a list of start and end PRB indices of each LBT bandwidth. In one non-limiting example, the parameter can be defined as follows for each serving cell:

| | |
|---|---|
| | {PRB-StartIndex1, |
| | PRB-EndIndex 1, |
| | PRB-StartIndex2, |
| | PRB-EndIndex 2, |
| | . . . |
| | PRB-StartIndexN, |
| PRBsPerLBT-Bandwidth | PRB-EndIndexN} |

In this example, the number of LBT bandwidths in a serving cell is equal to ½ the number of elements in the list.

In a variation of this embodiment, each LBW is defined by a set of contiguous or noncontiguous PRBs defined by an RRC parameter. Again, as should be understood by one of skill in the art upon reading this disclosure, the set of contiguous or non-contiguous PRBs is a set of contiguous or non-contiguous PRBs in the frequency domain, in a manner similar to LBWs or sub-bands.

Embodiment #4.1: An RRC parameter is defined to indicate the position of the bit for LBT bandwidth availability in the DCI e.g. LBWpositionInDCI.

LBWpositionInDCI
A sequence of numbers each indicating the starting position (bit) of
corresponding LBT bandwidth for the serving cell

### Embodiment #5

The DCI Format 2_0 in NR Rel-15 is extended to indicate the following parameters per LBT bandwidth:
End of channel occupancy for every LBT bandwidth.
COT sharing indication for configured UL transmission
LBT type/category for UL transmissions within gNB initiated COT

As a simplified case, a common or same value can be indicated for those LBT/serving cells with the same TDD pattern. As non-limiting examples, these parameters can be indicated as part of the SFI format or in separate fields in DCI format 2_0.

### Additional Description

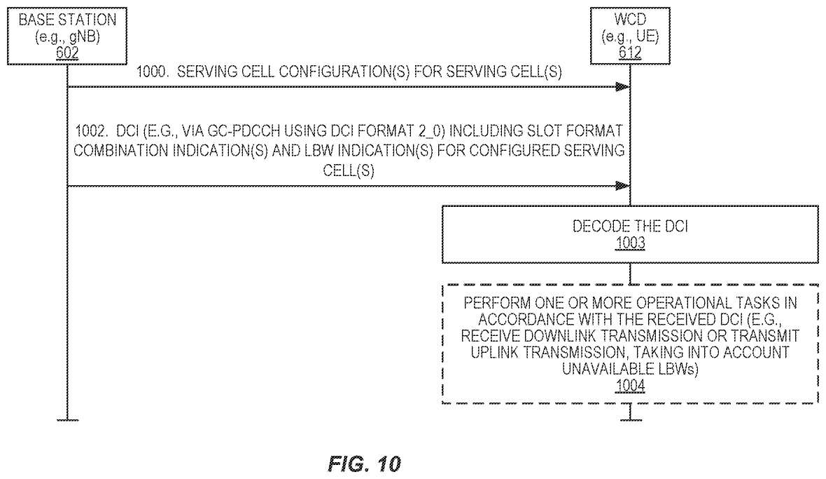

FIG. 10 illustrates the operation of a base station 602 and a wireless communication device 612 in accordance with at least some aspects of Embodiments #1 through #5 described above. Optional steps are represented by dashed lines or dashed boxes. Note that the functions illustrated as being performed by the base station 602 may be performed by a single network node or distributed across two or more network nodes depending on the particular implementation of the base station 602. For example, in some embodiments, the base station 602 is a gNB, where the gNB may include a Centralized Unit (gNB-CU) and one or more distributed units (gNB-DUs), where the gNB-CU and the gNB-DUs may be implemented on a single network node or on separate network nodes (e.g., at separate physical sites). Other variations are also possible.

As illustrated, the base station 602 sends one or more serving cell configurations for one or more serving cells to the wireless communication device 612 (step 1000). As discussed above, for each configured serving cell, the serving cell configurations may include, e.g., information that indicates a number of LBWs for the configured serving cell, information that indicates a bit position of a slot format combination indication (e.g., a SFI-index) for the configured serving cell in DCI, and/or information that indicates a bit position of a LBW indication (e.g., LBW bit-field) for the configured serving cell in DCI. In addition, as described above with respect to Embodiments #2 and #3, two or more of the configured serving cells may share the same slot format combination index and/or share the same LBW indication. For example, the serving cell configuration(s) may include the SlotFormatIndicatorIE described above with respect to Embodiment #4.

The base station 602 transmits, or initiates transmission of, DCI to the wireless communication device 612 either scheduling a downlink transmission to the wireless communication device 612 or providing an uplink grant to the wireless communication device 612 (step 1002). The DCI is, in some embodiments, transmitted on a GC-PDCCH using DCI format 2_0. The DCI includes a SFI combination indication(s) (e.g., SFI-index(es)) and a LBW indication(s) (e.g., LBW bit-field(s)) for the configured serving cell(s), as described above with respect to Embodiment #1, Embodiment #2, or Embodiment #3. In addition, in some embodiments, the DCI may additionally (or alternatively) include information that indicates one or more of the following parameters per LBW:
End of channel occupancy for every LBT bandwidth,
COT sharing indication for configured UL transmission,
LBT type/category for UL transmissions within gNB initiated COT, as described above with respect to Embodiment #5.

The wireless communication device 612 receives (step 1002) and decodes the DCI (step 1003). As will be appreciated by those of skill in the art upon reading the present disclosure, the decoding of the DCI includes identifying the locations (e.g., starting positions) of certain filed(s) in the DCI. For example, the decoding of the DCI includes identifying the locations (e.g., starting positions) of the SFI combination indications within the DCI based on the configurations received in step 1000 and/or identifying the locations (e.g., starting positions) of the LBW indications within the DCI based on the configurations received in step 1000. Using the LBW indication(s), the wireless communication device 612 the wireless communication device 612 is able to determine which LBT bandwidths are or are not available for the configured serving cell(s). The wireless communication device 612 performs one or more operational tasks in accordance with the received DCI (step 1004). For example, the wireless communication device 612 may receive a downlink transmission or transmit an uplink transmission, taking into account the availability of the LBT bandwidths of the configured serving cell(s) as indicated by the LBW indication(s) in the DCI.

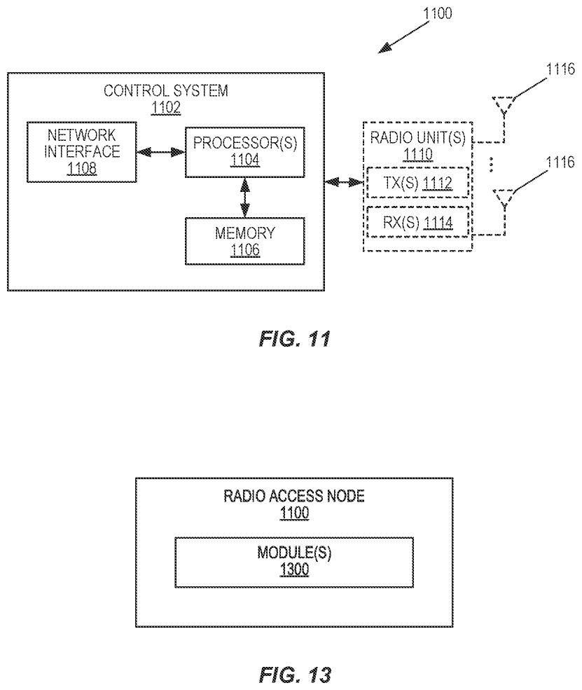

FIG. 11 is a schematic block diagram of a radio access node 1100 according to some embodiments of the present disclosure. Optional features are represented by dashed boxes. The radio access node 1100 may be, for example, a base station 602 or 606 or a network node that implements all or part of the functionality of the base station 602 or gNB described herein. As illustrated, the radio access node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. In addition, the radio access node 1100 may include one or more radio units 1110 that each includes one or more transmitters 1112 and one or more receivers 1114 coupled to one or more antennas 1116. The radio units 1110 may be referred to or be part of radio interface circuitry. In some embodiments, the radio unit(s) 1110 is external to the control system 1102 and connected to the control system 1102 via, e.g., a wired connection (e.g., an optical cable). However, in some other embodiments, the radio unit(s) 1110 and potentially the antenna(s) 1116 are integrated together with the control system 1102. The one or more processors 1104 operate to provide one or more functions of a radio access node 1100 as described herein. In some embodiments, the function(s) are implemented in software that is stored, e.g., in the memory 1106 and executed by the one or more processors 1104.

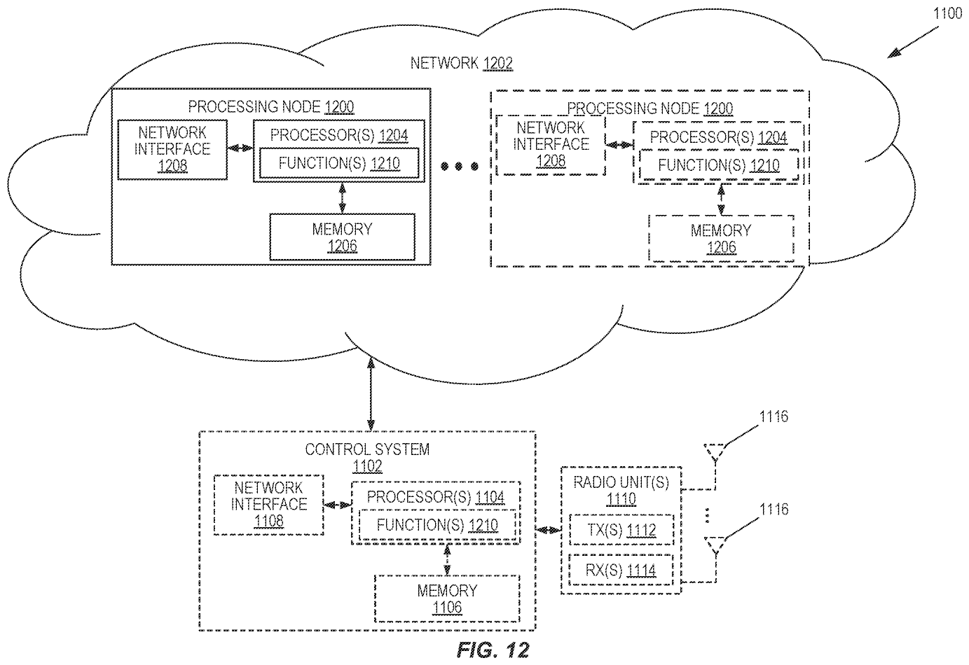

FIG. 12 is a schematic block diagram that illustrates a virtualized embodiment of the radio access node 1100 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1100 in which at least a portion of the functionality of the radio access node 1100 is implemented as a virtual component(s) (e.g., via a virtual machine(s) executing on a physical processing node(s) in a network(s)). As illustrated, in this example, the radio access node 1100 may include the control system 1102 and/or the one or more radio units 1110, as described above. The control system 1102 may be connected to the radio unit(s) 1110 via, for example, an optical cable or the like. The radio access node 1100 includes one or more processing nodes 1200 coupled to or included as part of a network(s) 1202. If present, the control system 1102 or the radio unit(s) are connected to the processing node(s) 1200 via the network 1202. Each processing node 1200 includes one or more processors 1204 (e.g., CPUs, ASICs, FPGAs, and/or the like), memory 1206, and a network interface 1208.

In this example, functions 1210 of the radio access node 1100 described herein are implemented at the one or more processing nodes 1200 or distributed across the one or more processing nodes 1200 and the control system 1102 and/or the radio unit(s) 1110 in any desired manner. In some particular embodiments, some or all of the functions 1210 of the radio access node 1100 described herein are implemented as virtual components executed by one or more virtual machines implemented in a virtual environment(s) hosted by the processing node(s) 1200. As will be appreciated by one of ordinary skill in the art, additional signaling or communication between the processing node(s) 1200 and the control system 1102 is used in order to carry out at least some of the desired functions 1210. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of radio access node 1100 or a node (e.g., a processing node 1200) implementing one or more of the functions 1210 of the radio access node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the radio access node 1100 according to some other embodiments of the present disclosure. The radio access node 1100 includes one or more modules 1300, each of which is implemented in software. The module(s) 1300 provide the functionality of the radio access node 1100 described herein. This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

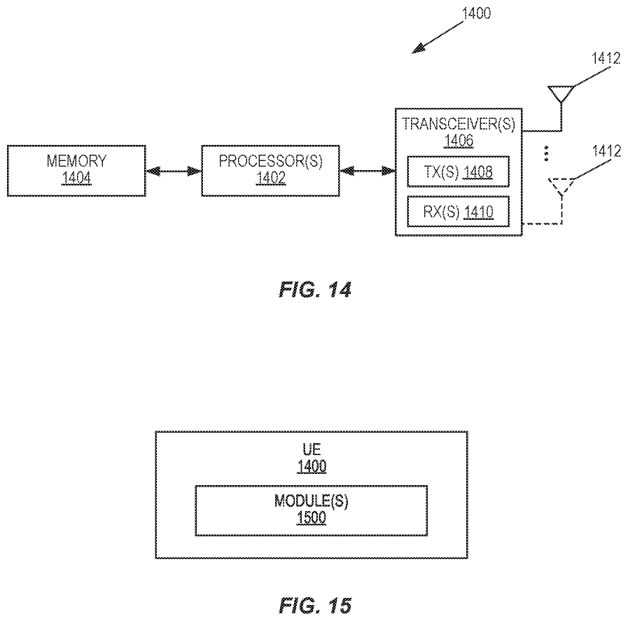

FIG. 14 is a schematic block diagram of a wireless communication device 1400 according to some embodiments of the present disclosure. As illustrated, the wireless communication device 1400 includes one or more processors 1402 (e.g., CPUs, ASICs, FPGAs, and/or the like), memory 1404, and one or more transceivers 1406 each including one or more transmitters 1408 and one or more receivers 1410 coupled to one or more antennas 1412. The transceiver(s) 1406 includes radio-front end circuitry connected to the antenna(s) 1412 that is configured to condition signals communicated between the antenna(s) 1412 and the processor(s) 1402, as will be appreciated by on of ordinary skill in the art. The processors 1402 are also referred to herein as processing circuitry. The transceivers 1406 are also referred to herein as radio circuitry. In some embodiments, the functionality of the wireless communication device 1400 described above may be fully or partially implemented in software that is, e.g., stored in the memory 1404 and executed by the processor(s) 1402. Note that the wireless communication device 1400 may include additional components not illustrated in FIG. 14 such as, e.g., one or more user interface components (e.g., an input/output interface including a display, buttons, a touch screen, a microphone, a speaker(s), and/or the like and/or any other components for allowing input of information into the wireless communication device 1400 and/or allowing output of information from the wireless communication device 1400), a power supply (e.g., a battery and associated power circuitry), etc.

In some embodiments, a computer program including instructions which, when executed by at least one processor, causes the at least one processor to carry out the functionality of the wireless communication device 1400 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the wireless communication device 1400 according to some other embodiments of the present disclosure. The wireless communication device 1400 includes one or more modules 1500, each of which is implemented in software. The module(s) 1500 provide the functionality of the wireless communication device 1400 described herein.

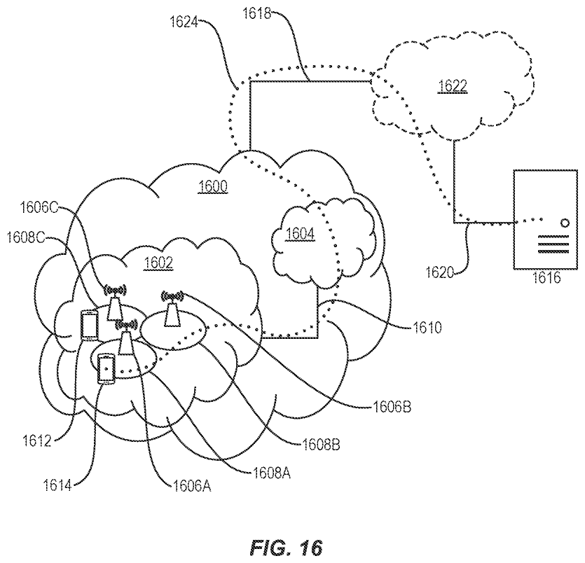

With reference to FIG. 16, in accordance with an embodiment, a communication system includes a telecommunication network 1600, such as a 3GPP-type cellular network, which comprises an access network 1602, such as a RAN, and a core network 1604. The access network 1602 comprises a plurality of base stations 1606A, 1606B, 1606C, such as Node Bs, eNBs, gNBs, or other types of wireless Access Points (APs), each defining a corresponding coverage area 1608A, 1608B, 1608C. Each base station 1606A, 1606B, 1606C is connectable to the core network 1604 over a wired or wireless connection 1610. A first UE 1612 located in coverage area 1608C is configured to wirelessly connect to, or be paged by, the corresponding base station 1606C. A second UE 1614 in coverage area 1608A is wirelessly connectable to the corresponding base station 1606A. While a plurality of UEs 1612, 1614 are illustrated in this example, the disclosed embodiments are equally applicable to a situation where a sole UE is in the coverage area or where a sole UE is connecting to the corresponding base station 1606.

The telecommunication network 1600 is itself connected to a host computer 1616, which may be embodied in the hardware and/or software of a standalone server, a cloud-implemented server, a distributed server, or as processing resources in a server farm. The host computer 1616 may be under the ownership or control of a service provider, or may be operated by the service provider or on behalf of the service provider. Connections 1618 and 1620 between the telecommunication network 1600 and the host computer 1616 may extend directly from the core network 1604 to the host computer 1616 or may go via an optional intermediate network 1622. The intermediate network 1622 may be one of, or a combination of more than one of, a public, private, or hosted network; the intermediate network 1622, if any, may be a backbone network or the Internet; in particular, the intermediate network 1622 may comprise two or more sub-networks (not shown).

The communication system of FIG. 16 as a whole enables connectivity between the connected UEs 1612, 1614 and the host computer 1616. The connectivity may be described as an Over-the-Top (OTT) connection 1624. The host computer 1616 and the connected UEs 1612, 1614 are configured to communicate data and/or signaling via the OTT connection 1624, using the access network 1602, the core network 1604, any intermediate network 1622, and possible further infrastructure (not shown) as intermediaries. The OTT connection 1624 may be transparent in the sense that the participating communication devices through which the OTT connection 1624 passes are unaware of routing of uplink and downlink communications. For example, the base station 1606 may not or need not be informed about the past routing of an incoming downlink communication with data originating from the host computer 1616 to be forwarded (e.g., handed over) to a connected UE 1612. Similarly, the base station 1606 need not be aware of the future routing of an outgoing uplink communication originating from the UE 1612 towards the host computer 1616.

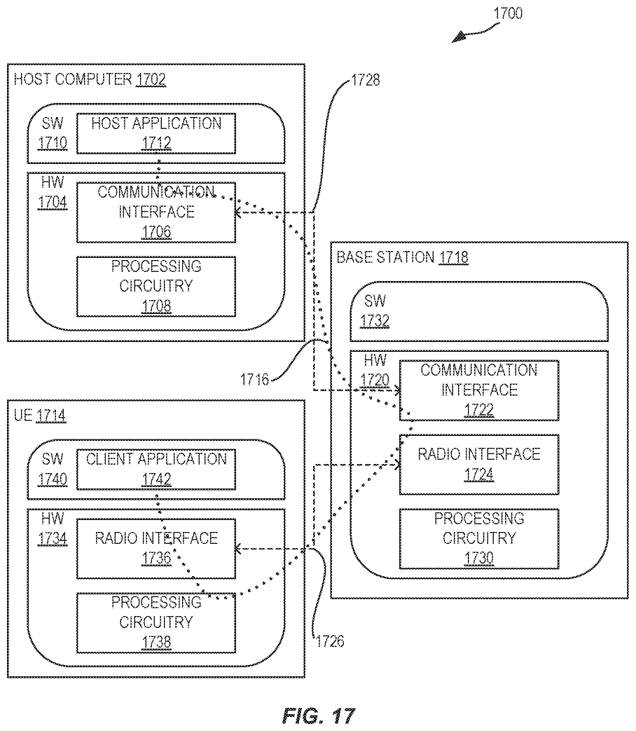

Example implementations, in accordance with an embodiment, of the UE, base station, and host computer discussed in the preceding paragraphs will now be described with reference to FIG. 17. In a communication system 1700, a host computer 1702 comprises hardware 1704 including a communication interface 1706 configured to set up and maintain a wired or wireless connection with an interface of a different communication device of the communication system 1700. The host computer 1702 further comprises processing circuitry 1708, which may have storage and/or processing capabilities. In particular, the processing circuitry 1708 may comprise one or more programmable processors, ASICs, FPGAs, or combinations of these (not shown) adapted to execute instructions. The host computer 1702 further comprises software 1710, which is stored in or accessible by the host computer 1702 and executable by the processing circuitry 1708. The software 1710 includes a host application 1712. The host application 1712 may be operable to provide a service to a remote user, such as a UE 1714 connecting via an OTT connection 1716 terminating at the UE 1714 and the host computer 1702. In providing the service to the remote user, the host application 1712 may provide user data which is transmitted using the OTT connection 1716.

The communication system 1700 further includes a base station 1718 provided in a telecommunication system and comprising hardware 1720 enabling it to communicate with the host computer 1702 and with the UE 1714. The hardware 1720 may include a communication interface 1722 for setting up and maintaining a wired or wireless connection with an interface of a different communication device of the communication system 1700, as well as a radio interface 1724 for setting up and maintaining at least a wireless connection 1726 with the UE 1714 located in a coverage area (not shown in FIG. 17) served by the base station 1718. The communication interface 1722 may be configured to facilitate a connection 1728 to the host computer 1702. The connection 1728 may be direct or it may pass through a core network (not shown in FIG. 17) of the telecommunication system and/or through one or more intermediate networks outside the telecommunication system. In the embodiment shown, the hardware 1720 of the base station 1718 further includes processing circuitry 1730, which may comprise one or more programmable processors, ASICs, FPGAs, or combinations of these (not shown) adapted to execute instructions. The base station 1718 further has software 1732 stored internally or accessible via an external connection.

The communication system 1700 further includes the UE 1714 already referred to. The UE's 1714 hardware 1734 may include a radio interface 1736 configured to set up and maintain a wireless connection 1726 with a base station serving a coverage area in which the UE 1714 is currently located. The hardware 1734 of the UE 1714 further includes processing circuitry 1738, which may comprise one or more programmable processors, ASICs, FPGAs, or combinations of these (not shown) adapted to execute instructions. The UE 1714 further comprises software 1740, which is stored in or accessible by the UE 1714 and executable by the processing circuitry 1738. The software 1740 includes a client application 1742. The client application 1742 may be operable to provide a service to a human or non-human user via the UE 1714, with the support of the host computer 1702. In the host computer 1702, the executing host application 1712 may communicate with the executing client application 1742 via the OTT connection 1716 terminating at the UE 1714 and the host computer 1702. In providing the service to the user, the client application 1742 may receive request data from the host application 1712 and provide user data in response to the request data. The OTT connection 1716 may transfer both the request data and the user data. The client application 1742 may interact with the user to generate the user data that it provides.

It is noted that the host computer 1702, the base station 1718, and the UE 1714 illustrated in FIG. 17 may be similar or identical to the host computer 1616, one of the base stations 1606A, 1606B, 1606C, and one of the UEs 1612, 1614 of FIG. 16, respectively. This is to say, the inner workings of these entities may be as shown in FIG. 17 and independently, the surrounding network topology may be that of FIG. 16.

In FIG. 17, the OTT connection 1716 has been drawn abstractly to illustrate the communication between the host computer 1702 and the UE 1714 via the base station 1718 without explicit reference to any intermediary devices and the precise routing of messages via these devices. The network infrastructure may determine the routing, which may be configured to hide from the UE 1714 or from the service provider operating the host computer 1702, or both. While the OTT connection 1716 is active, the network infrastructure may further take decisions by which it dynamically changes the routing (e.g., on the basis of load balancing consideration or reconfiguration of the network).

The wireless connection 1726 between the UE 1714 and the base station 1718 is in accordance with the teachings of the embodiments described throughout this disclosure. One or more of the various embodiments improve the performance of OTT services provided to the UE 1714 using the OTT connection 1716, in which the wireless connection 1726 forms the last segment.

A measurement procedure may be provided for the purpose of monitoring data rate, latency, and other factors on which the one or more embodiments improve. There may further be an optional network functionality for reconfiguring the OTT connection 1716 between the host computer 1702 and the UE 1714, in response to variations in the measurement results. The measurement procedure and/or the network functionality for reconfiguring the OTT connection 1716 may be implemented in the software 1710 and the hardware 1704 of the host computer 1702 or in the software 1740 and the hardware 1734 of the UE 1714, or both. In some embodiments, sensors (not shown) may be deployed in or in association with communication devices through which the OTT connection 1716 passes; the sensors may participate in the measurement procedure by supplying values of the monitored quantities exemplified above, or supplying values of other physical quantities from which the software 1710, 1740 may compute or estimate the monitored quantities. The reconfiguring of the OTT connection 1716 may include message format, retransmission settings, preferred routing, etc.; the reconfiguring need not affect the base station 1718, and it may be unknown or imperceptible to the base station 1718. Such procedures and functionalities may be known and practiced in the art. In certain embodiments, measurements may involve proprietary UE signaling facilitating the host computer 1702′s measurements of throughput, propagation times, latency, and the like. The measurements may be implemented in that the software 1710 and 1740 causes messages to be transmitted, in particular empty or ‘dummy’ messages, using the OTT connection 1716 while it monitors propagation times, errors, etc.

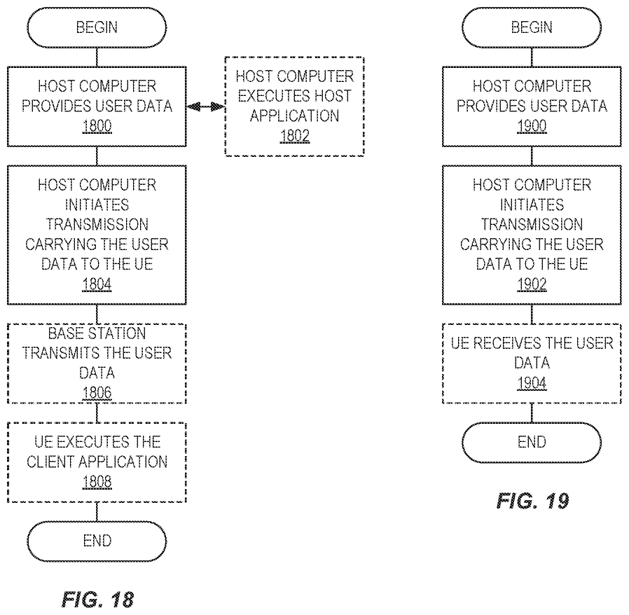

FIG. 18 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 18 will be included in this section. In step 1800, the host computer provides user data. In sub-step 1802 (which may be optional) of step 1800, the host computer provides the user data by executing a host application. In step 1804, the host computer initiates a transmission carrying the user data to the UE. In step 1806 (which may be optional), the base station transmits to the UE the user data which was carried in the transmission that the host computer initiated, in accordance with the teachings of the embodiments described throughout this disclosure. In step 1808 (which may also be optional), the UE executes a client application associated with the host application executed by the host computer.

FIG. 19 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 19 will be included in this section. In step 1900 of the method, the host computer provides user data. In an optional sub-step (not shown) the host computer provides the user data by executing a host application. In step 1902, the host computer initiates a transmission carrying the user data to the UE. The transmission may pass via the base station, in accordance with the teachings of the embodiments described throughout this disclosure. In step 1904 (which may be optional), the UE receives the user data carried in the transmission.

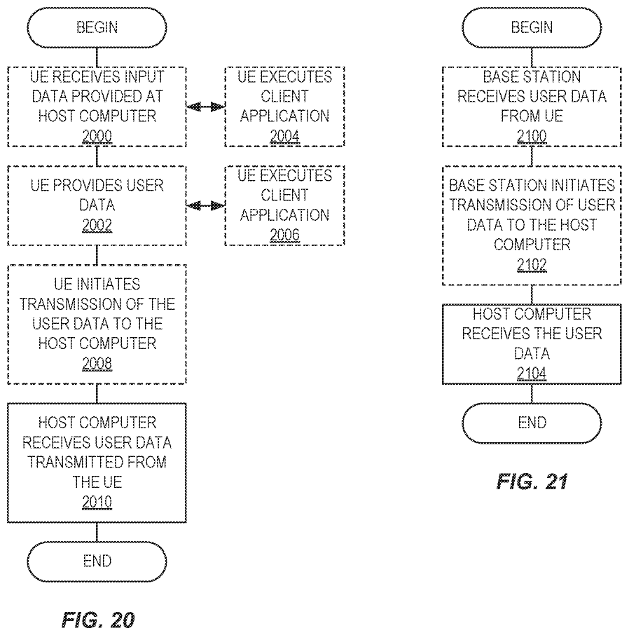

FIG. 20 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 20 will be included in this section. In step 2000 (which may be optional), the UE receives input data provided by the host computer. Additionally or alternatively, in step 2002, the UE provides user data. In sub-step 2004 (which may be optional) of step 2000, the UE provides the user data by executing a client application. In sub-step 2006 (which may be optional) of step 2002, the UE executes a client application which provides the user data in reaction to the received input data provided by the host computer. In providing the user data, the executed client application may further consider user input received from the user. Regardless of the specific manner in which the user data was provided, the UE initiates, in sub-step 2008 (which may be optional), transmission of the user data to the host computer. In step 2010 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 21 will be included in this section. In step 2100 (which may be optional), in accordance with the teachings of the embodiments described throughout this disclosure, the base station receives user data from the UE. In step 2102 (which may be optional), the base station initiates transmission of the received user data to the host computer. In step 2104 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a wireless communication device (612), the method comprising receiving (1002) a downlink control information, DCI, comprising one or more slot format combination indications for one or more configured serving cells of the wireless communication device (612) and one or more Listen Before Talk, LBT, bandwidth availability indications for the one or more configured serving cells of the wireless communication device (612).

Embodiment 2: The method of embodiment 1 further comprising performing one or more operational tasks in accordance with the received DCI.

Embodiment 3: The method of embodiment 2 wherein the received DCI schedules a downlink transmission, and the one or more operational tasks comprises receiving the downlink transmission taking into consideration availability of LBT bandwidths of the one or more configured serving cells as indicated by the one or more LBT bandwidth indications for the one or more configured serving cells.

Embodiment 4: The method of embodiment 2 wherein the received DCI comprises an uplink grant for an uplink transmission, and the one or more operational tasks comprises transmitting the uplink transmission taking into consideration availability of LBT bandwidths of the one or more configured serving cells as indicated by the one or more LBT bandwidth indications for the one or more configured serving cells.

Embodiment 5: The method of any one of embodiments 1 to 4 wherein the DCI comprises one slot format combination indication and one LBT bandwidth availability indication per configured serving cell.

Embodiment 6: The method of any one of embodiments 1 to 4 wherein the DCI comprises one slot format combination indication per configured serving cell and at least two of the configured serving cells share a same LBT bandwidth availability indication.

Embodiment 7: The method of any one of embodiments 1 to 4 wherein the DCI comprises one LBT bandwidth availability indication per configured serving cell and at least two of the configured serving cells share a same slot formation combination indication.

Embodiment 8: The method of any one of embodiments 1 to 7 further comprising receiving (1000) a serving cell configuration(s) for the one or more serving cells of the wireless communication device (612).

Embodiment 9: The method of embodiment 8 wherein the serving cell configuration(s) comprise, for at least one of the one or more serving cells, an indication of the number of LBT bandwidths (also referred to herein as subbands) within a total bandwidth of the serving cell.

Embodiment 10: The method of embodiment 8 or 9 wherein the serving cell configuration(s) comprise, for at least one of the one or more serving cells, an indication of a bit position of the LBT bandwidth indications for the LBT bandwidths of the serving cell within DCI.

Embodiment 11: The method of any of embodiments 1 to 10 wherein the DCI further comprises, for at least one of the LBT bandwidths in at least one of the one or more serving cells, one or more of the following parameters: a parameter that indicates an end of channel occupancy; a Channel Occupancy Time, COT, sharing indication; a parameter that indicates a LBT type or category for uplink transmissions (e.g., within network initiated COT).

Embodiment 12: The method of any one of the preceding embodiments, wherein receiving the DCI comprises receiving the DCI on a GC-PDCCH.

Embodiment 13: The method of the preceding embodiment, wherein receiving the DCI on the GC-PDCCH comprises receiving the DCI on the GC-PDCCH in accordance with DCI format 2_0.

Embodiment 14: The method of any of the preceding embodiments wherein the one or more configured serving cells are one or more NR-U cells.

Embodiment 15: The method of any of the previous embodiments, further comprising: providing user data; and forwarding the user data to a host computer via the transmission to the base station.

### Group B Embodiments

Embodiment 16: A method performed by a network node (e.g., a base station or component of a base station), the method comprising: transmitting or initiating transmission of (1002) a downlink control information, DCI, to a wireless communication device (612), the DCI comprising one or more slot format combination indications for one or more configured serving cells of the wireless communication device (612) and one or more Listen Before Talk, LBT, bandwidth availability indications for the one or more configured serving cells of the wireless communication device (612).

Embodiment 17: The method of embodiment 16 wherein the DCI comprises one slot format combination indication and one LBT bandwidth availability indication per configured serving cell.

Embodiment 18: The method of embodiment 16 wherein the DCI comprises one slot format combination indication per configured serving cell and at least two of the configured serving cells share a same LBT bandwidth availability indication.

Embodiment 19: The method of embodiment 16 wherein the DCI comprises one LBT bandwidth availability indication per configured serving cell and at least two of the configured serving cells share a same slot formation combination indication.

Embodiment 20: The method of any one of embodiments 16 to 19 further comprising transmitting or initiating transmission of (1000) a serving cell configuration(s) for the one or more serving cells of the wireless communication device (612).

Embodiment 21: The method of embodiment 20 wherein the serving cell configuration(s) comprise, for at least one of the one or more serving cells, an indication of the number of LBT bandwidths (also referred to herein as subbands) within a total bandwidth of the serving cell.

Embodiment 22: The method of embodiment 20 or 21 wherein the serving cell configuration(s) comprise, for at least one of the one or more serving cells, an indication of a bit position of the LBT bandwidth indications for the LBT bandwidths of the serving cell within DCI.

Embodiment 23: The method of any of embodiments 16 to 22 wherein the DCI further comprises, for at least one of the LBT bandwidths in at least one of the one or more serving cells, one or more of the following parameters: a parameter that indicates an end of channel occupancy; a Channel Occupancy Time, COT, sharing indication; a parameter that indicates a LBT type or category for uplink transmissions (e.g., within network initiated COT).

Embodiment 24: The method of any one of the preceding embodiments, wherein transmitting or initiating transmission of (1002) the DCI comprises transmitting or initiating transmission of (1002) the DCI on a GC-PDCCH.

Embodiment 25: The method of the preceding embodiment, wherein transmitting or initiating transmission of (1002) the DCI on the GC-PDCCH comprises transmitting or initiating transmission of (1002) the DCI on the GC-PDCCH in accordance with DCI format 2_0.

Embodiment 26: The method of any of the preceding embodiments wherein the one or more configured serving cells are one or more NR-U cells.

Embodiment 27: The method of any of the previous embodiments, further comprising: obtaining user data; and forwarding the user data to a host computer or a wireless communication device.

### Group C Embodiments

Embodiment 28: A wireless communication device comprising: processing circuitry configured to perform any of the steps of any of the Group A embodiments; and power supply circuitry configured to supply power to the wireless communication device.

Embodiment 29: A base station comprising: processing circuitry configured to perform any of the steps of any of the Group B embodiments; and power supply circuitry configured to supply power to the base station.

Embodiment 30: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 31: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 32: The communication system of the previous embodiment further including the base station.

Embodiment 33: The communication system of the previous 2 embodiments, further including the UE, wherein the UE is configured to communicate with the base station.

Embodiment 34: The communication system of the previous 3 embodiments, wherein: the processing circuitry of the host computer is configured to execute a host application, thereby providing the user data; and the UE comprises processing circuitry configured to execute a client application associated with the host application.

Embodiment 35: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 36: The method of the previous embodiment, further comprising, at the base station, transmitting the user data.

Embodiment 37: The method of the previous 2 embodiments, wherein the user data is provided at the host computer by executing a host application, the method further comprising, at the UE, executing a client application associated with the host application.

Embodiment 38: A User Equipment, UE, configured to communicate with a base station, the UE comprising a radio interface and processing circuitry configured to perform the method of the previous 3 embodiments.

Embodiment 39: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 40: The communication system of the previous embodiment, wherein the cellular network further includes a base station configured to communicate with the UE.

Embodiment 41: The communication system of the previous 2 embodiments, wherein: the processing circuitry of the host computer is configured to execute a host application, thereby providing the user data; and the UE's processing circuitry is configured to execute a client application associated with the host application.

Embodiment 42: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 43: The method of the previous embodiment, further comprising at the UE, receiving the user data from the base station.

Embodiment 44: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 45: The communication system of the previous embodiment, further including the UE.

Embodiment 46: The communication system of the previous 2 embodiments, further including the base station, wherein the base station comprises a radio interface configured to communicate with the UE and a communication interface configured to forward to the host computer the user data carried by a transmission from the UE to the base station.

Embodiment 47: The communication system of the previous 3 embodiments, wherein: the processing circuitry of the host computer is configured to execute a host application; and the UE's processing circuitry is configured to execute a client application associated with the host application, thereby providing the user data.

Embodiment 48: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 49: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 50: The method of the previous embodiment, further comprising, at the UE, providing the user data to the base station.

Embodiment 51: The method of the previous 2 embodiments, further comprising: at the UE, executing a client application, thereby providing the user data to be transmitted; and at the host computer, executing a host application associated with the client application.

Embodiment 52: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 53: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 54: The communication system of the previous embodiment further including the base station.

Embodiment 55: The communication system of the previous 2 embodiments, further including the UE, wherein the UE is configured to communicate with the base station.

Embodiment 56: The communication system of the previous 3 embodiments, wherein: the processing circuitry of the host computer is configured to execute a host application; and the UE is configured to execute a client application associated with the host application, thereby providing the user data to be received by the host computer.

Embodiment 57: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 58: The method of the previous embodiment, further comprising at the base station, receiving the user data from the UE.

Embodiment 59: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1-43. (canceled)

44. A method performed by a wireless communication device for a cellular communications system, the method comprising:
receiving serving cell configurations for one or more configured serving cells of the wireless communication device, the one or more configured serving cells being one or more configured serving cells of the wireless communication device that require Listen-Before-Talk, LBT;
receiving a Downlink Control Information, DCI, from a network node, the DCI comprising:
one or more slot format combination indications for one or more configured serving cells of the wireless communication device, wherein each slot format combination indication from among the one or more slot format combination indications is an indication of one or more slot formats for one or more slots on at least one respective configured serving cell from among the one or more configured serving cells of the wireless communication device; and
one or more Resource Block, RB, set indications for the one or more configured serving cells of the wireless communication device, wherein each RB set indication from among the one or more RB set indications comprises one or more bits that indicate availability of one or more RB sets for at least one respective configured serving cell from among the one or more configured serving cells of the wireless communication device; and
decoding the DCI based on the serving cell configurations;
wherein a format of the DCI is such that the one or more slot format combination indications are comprised in a first set of bits in the DCI and the one or more RB set indications are comprised in a second set of bits in the DCI.

45. The method of claim 44 further comprising performing one or more operational tasks in accordance with the received DCI.

46. The method of claim 44 wherein the second set of bits are located in bit positions within the DCI that are all after a bit position of a last bit of the first set of bits within the DCI.

47. The method of any of claim 44 wherein decoding the DCI based on the serving cell configurations comprises identifying starting positions of the slot format combination indications in the DCI based on the serving cell configurations.

48. The method of claim 44 wherein decoding the DCI based on the serving cell configurations comprises identifying starting positions of the RB set indications in the DCI based on one or more RRC parameters.

49. The method of claim 48 wherein the RRC parameter is a parameter positionInDCI comprised in a field in a SlotFormatIndicator Information Element, IE.

50. The method of claim 44 wherein, for each RB set indication from among the one or more RB set indications, the one or more bits comprised in the RB set indication are associated to the one or more respective RB sets for the at least one respective configured serving cell via Radio Resource Control, RRC, parameters.

51. The method of claim 44 wherein the DCI further comprises, for at least one of the one or more RB sets for at least one of the one or more configured serving cells, one or more of the following parameters:
a Channel Occupancy Time, COT, sharing indication;
a parameter that indicates a Listen-Before-Talk, LBT, type or category for uplink transmissions; and
a parameter that indicates an end of channel occupancy for the configured serving cell for the at least one of the one or more RB sets.

52. A wireless communication device for a cellular communications system, the wireless communication device comprising:
one or more transmitters;
one or more receivers; and
processing circuitry associated with the one or more transmitters and the one or more receivers, the processing circuitry configured to cause the wireless communication device to:
receive serving cell configurations for one or more configured serving cells of the wireless communication device, the one or more configured serving cells being one or more configured serving cells of the wireless communication device that require Listen-Before-Talk, LBT;
receive a Downlink Control Information, DCI, from a network node, the DCI comprising:
one or more slot format combination indications for one or more configured serving cells of the wireless communication device, wherein each slot format combination indication from among the one or slot format combination indications is an indication of one or more slot formats for one or more slots on at least one respective configured serving cell from among the one or more configured serving cells of the wireless communication device; and
one or more Resource Block, RB, set indications for the one or more configured serving cells of the wireless communication device, wherein each RB set indication from among the one or more RB set indications comprises one or more bits that indicate availability of one or more RB sets for at least one respective configured serving cell from among the one or more configured serving cells of the wireless communication device; and
decode the DCI based on the serving cell configuration;
wherein a format of the DCI is such that the one or more slot format combination indications are comprised in a first set of bits in the DCI and the one or more RB set indications are comprised in a second set of bits in the DCI.

53. The wireless communication device of claim 52 wherein the wireless communication device, for a cellular communications system, is further adapted to perform the method of comprising:
receiving serving cell configurations for one or more configured serving cells of the wireless communication device, the one or more configured serving cells being one or more configured serving cells of the wireless communication device that require Listen-Before-Talk, LBT;
receiving a Downlink Control Information, DCI, from a network node, the DCI comprising:
one or more slot format combination indications for one or more configured serving cells of the wireless communication device, wherein each slot format combination indication from among the one or more slot format combination indications is an indication of one or more slot formats for one or more slots on at least one respective configured serving cell from among the one or more configured serving cells of the wireless communication device; and
one or more Resource Block, RB, set indications for the one or more configured serving cells of the wireless communication device, wherein each RB set indication from among the one or more RB set indications comprises one or more bits that indicate availability of one or more RB sets for at least one respective configured serving cell from among the one or more configured serving cells of the wireless communication device; and
decoding the DCI based on the serving cell configurations;
wherein a format of the DCI is such that the one or more slot format combination indications are comprised in a first set of bits in the DCI and the one or more RB set indications are comprised in a second set of bits in the DCI.

54. A method performed by a network node for a cellular communications system, the method comprising:
transmitting or initiating transmission of, to a wireless communication device, serving cell configurations for one or more configured serving cells of the wireless communication device, the one or more configured serving cells being one or more configured serving cells of the wireless communication device that require Listen-Before-Talk, LBT;
transmitting or initiating transmission of a Downlink Control Information, DCI, to the wireless communication device, the DCI comprising:
one or more slot format combination indications for one or more configured serving cells of the wireless communication device, wherein each slot format combination indication from among the one or slot format combination indications is an indication of one or more slot formats for one or more slots on at least one respective configured serving cell from among the one or more configured serving cells of the wireless communication device; and
one or more Resource Block, RB, set indications for the one or more configured serving cells of the wireless communication device, wherein each RB set indication from among the one or more RB set indications comprises one or more bits that indicate availability of one or more RB sets for at least one respective configured serving cell from among the one or more configured serving cells of the wireless communication device;
wherein a format of the DCI is such that the one or more slot format combination indications are comprised in a first set of bits in the DCI and the one or more RB set indications are comprised in a second set of bits in the DCI.

55. The method of claim 54 wherein the second set of bits are located in bit positions within the DCI that are all after a bit position of a last bit of the first set of bits within the DCI.

56. The method of claim 54 wherein the serving cell configurations comprise, for each serving cell from among the one or more configured serving cells of the wireless communication device, a Radio Resource Control, RRC, parameter that indicates a location of a respective one of the one or more RB set indications for the configured serving cell in the DCI, and wherein the RRC parameter is a parameter positionInDCI comprised in a field in a SlotFormatIndicator Information Element, IE.

57. The method of claim 54 wherein the serving cell configurations comprise, for at least one of the one or more configured serving cells, an indication of a number of RB sets within a total bandwidth of the serving cell.

58. The method of claim 54 wherein, for each RB set indication from among the one or more RB set indications, the one or more bits comprised in the RB set indication are associated to the one or more respective RB sets for the at least one respective configured serving cell in sequential order.

59. The method of claim 54 wherein, for each RB set indication from among the one or more RB set indications, the one or more bits comprised in the RB set indication are associated to the one or more respective RB sets for the at least one respective configured serving cell via RRC parameters.

60. The method of claim 54 wherein the one or more configured serving cells comprise two or more configured serving cells, the DCI comprises one slot format combination indication per configured serving cell, and at least two of the two or more configured serving cells share a same RB set indication.

61. The method of claim 54 wherein the DCI further comprises, for at least one of the one or more RB sets for at least one of the one or more configured serving cells, one or more of the following parameters:
a Channel Occupancy Time, COT, sharing indication;
a parameter that indicates a Listen-Before-Talk, LBT, type or category for uplink transmissions; and
a parameter that indicates an end of channel occupancy for the configured serving cell for the at least one of the one or more RB sets.

62. A network node for a cellular communications system, the network node comprising processing circuitry configured to cause the network node to:
transmit or initiate transmission of, to a wireless communication device, serving cell configurations for one or more configured serving cells of the wireless communication device, the one or more configured serving cells being one or more configured serving cells of the wireless communication device that require Listen-Before-Talk, LBT;
transmit or initiate transmission of a Downlink Control Information, DCI, to the wireless communication device, the DCI comprising:
one or more slot format combination indications for one or more configured serving cells of the wireless communication device, wherein each slot format combination indication from among the one or slot format combination indications is an indication of one or more slot formats for one or more slots on at least one respective configured serving cell from among the one or more configured serving cells of the wireless communication device; and
one or more Resource Block, RB, set indications for the one or more configured serving cells of the wireless communication device, wherein each RB set indication from among the one or more RB set indications comprises one or more bits that indicate availability of one or more RB sets for at least one respective configured serving cell from among the one or more configured serving cells of the wireless communication device;
wherein a format of the DCI is such that the one or more slot format combination indications are comprised in a first set of bits in the DCI and the one or more RB set indications are comprised in a second set of bits in the DCI.

63. The network node of claim 62 wherein the network node for a cellular communications system is further adapted to perform the method comprising:
transmitting or initiating transmission of, to a wireless communication device, serving cell configurations for one or more configured serving cells of the wireless communication device, the one or more configured serving cells being one or more configured serving cells of the wireless communication device that require Listen-Before-Talk, LBT;
transmitting or initiating transmission of a Downlink Control Information, DCI, to the wireless communication device, the DCI comprising:
one or more slot format combination indications for one or more configured serving cells of the wireless communication device, wherein each slot format combination indication from among the one or slot format combination indications is an indication of one or more slot formats for one or more slots on at least one respective configured serving cell from among the one or more configured serving cells of the wireless communication device; and
one or more Resource Block, RB, set indications for the one or more configured serving cells of the wireless communication device, wherein each RB set indication from among the one or more RB set indications comprises one or more bits that indicate availability of one or more RB sets for at least one respective configured serving cell from among the one or more configured serving cells of the wireless communication device;
wherein a format of the DCI is such that the one or more slot format combination indications are comprised in a first set of bits in the DCI and the one or more RB set indications are comprised in a second set of bits in the DCI, and
wherein the second set of bits are located in bit positions within the DCI that are all after a bit position of a last bit of the first set of bits within the DCI.
